(19) United States
(12) Patent Application Publication
(10) Pub. No.: US 2023/0398486 A1
(43) Pub. Date: Dec. 14, 2023

(54) ARTICLES, SYSTEMS, AND METHODS INCLUDING ARTICLES WITH HALOGEN RESERVOIRS

(71) Applicant: W. L. Gore & Associates, Inc., Newark, DE (US)

(72) Inventors: Steve Hardwick, Newark, DE (US); Franz Shelley, Oxford, PA (US); Lisandra Arroyo Ramirez, Newark, DE (US); Ryan Kenaley, Hockessin, DE (US); Vladimiros Nikolakis, Newark, DE (US); Uwe Beuscher, Newark, DE (US)

(21) Appl. No.: 18/036,608

(22) PCT Filed: Nov. 12, 2021
(86) PCT No.: PCT/US2021/059114

§ 371 Date: May 11, 2023

Related U.S. Application Data
(60) Provisional application No. 63/113,022, filed on Nov. 12, 2020.

(51) Int. Cl. B01D 53/04; B01D 53/64

(52) U.S. Cl. CPC B01D 53/04; B01D 53/64; B01D 2253/102; B01D 2257/602; B01D 2258/0283; B01D 2257/302; B01D 2253/202

(57) ABSTRACT

A durable pollution control systems, articles, and methods for removing multiple flue gas pollutants. The pollution control system can provide a source of halogen in the required amount for a prolonged period of time. The halogen source is combined with a sorbent polymer composite substrate, configured such that the halogen does not get leached away in solutions formed during the pollution gas treatment process.

### CROSS-REFERENCE TO RELATED APPLICATIONS

The present application is a national phase application of PCT Application No. PCT/US2021/059114, internationally filed on Nov. 12, 2021, and entitled ARTICLES, SYSTEMS, AND METHODS INCLUDING ARTICLES WITH HALOGEN RESERVOIRS, which claims priority to and benefit of U.S. Provisional Patent Application No. 63/113,022, filed Nov. 12, 2020, and entitled “LAYERED ARTICLES COMPRISING A HALOGEN RESERVOIR, SYSTEMS AND METHODS INCLUDING THE SAME,” the entireties of which are herein incorporated by reference.

### FIELD

The present disclosure relates to the field of pollution control systems and methods for removing compounds and fine particulate matters from gas streams.

### BACKGROUND

Coal-fired power generation plants, municipal waste incinerators, and oil refinery plants generate large amounts of flue gases that contain substantial varieties and quantities of environmental pollutants, such as sulfur oxides (SO₂, and SO₃), nitrogen oxides (NO, NO₂), mercury (Hg) vapor, and particulate matters (PM). In the United States, burning coal alone generates about 27 million tons of SO₂ and 45 tons of Hg each year. Thus, there is a need for improvements to control systems and methods for removing sulfur oxides, mercury vapor, and fine particulate matters from industrial flue gases, such as coal-fired power plant flue gas.

### SUMMARY

In some embodiments, an improved durable pollution control system is provided that may simultaneously remove multiple flue gas pollutants. These pollutants may include, but are not limited to for example, SOₓ, Hg vapor, and PM2.5 (particulate matter having a diameter of 2.5 micrometers or less). Some embodiments may include a simple pollution control system which may not generate secondary pollutants. In some embodiments, a pollution control system that may provide a source of halogen in a required amount for a prolonged period of time. In particular, a flue gas treatment device may include a more durable and longer lasting halogen source in combination with a sorbent polymer composite substrate. In some embodiments, the sorbent polymer substrate may not get leached away in solutions developed in the treatment process. Some embodiments of the present disclosure relate to articles having a layered structure, which can include a halogen source and an SPC. In some embodiments, the articles described herein can allow for delayed release of at least one halogen source from a halogen reservoir, which may form a part of the articles described herein.

In some embodiments, the article includes a flue gas treatment device. In some embodiments, the article is a flue gas treatment device. In some embodiments, the article is a part of a flue gas treatment device.

In some embodiments, an article comprises a first sorbent polymer composite (SPC) layer; a second SPC layer; and a halogen reservoir, wherein the halogen reservoir is disposed between the first SPC layer and the second SPC layer.

In some embodiments, the article comprises or further comprises at least one permeation control material.

In some embodiments of the article, the at least one permeation control material is in a form of at least one permeation control layer, wherein the at least one permeation control layer is disposed between the first SPC layer and the halogen reservoir, between the second SPC layer and the halogen reservoir, or both. That is, in some embodiments of the article, the at least one permeation control material is in the form of at least one permeation control layer, wherein the at least one permeation control layer is disposed between the first SPC layer and the halogen reservoir, and also between the second SPC layer and the halogen reservoir.

In some embodiments of the article, the at least one permeation control layer comprises a first layer of the at least one permeation control material, wherein the first layer is disposed between the first SPC layer and the halogen reservoir; and a second layer of the at least one permeation control material, wherein the second layer is disposed between the second SPC layer and the halogen reservoir.

In some embodiments of the article, the halogen reservoir comprises at least one halogen source.

In some embodiments of the article, the at least one halogen source comprises at least one halide ion or an elemental halogen.

In some embodiments of the article, the halogen reservoir comprises 0.1 wt % to 50 wt % of the at least one halogen source based on a total weight of the halogen reservoir.

In some embodiments of the article, the halogen reservoir comprises an SPC.

In some embodiments of the article, the halogen reservoir comprises a third SPC layer.

In some embodiments of the article, at least one of the first SPC layer, the second SPC layer, or the third SPC layer comprises at least one halogen source.

In some embodiments of the article, the first SPC layer, the second SPC layer, and the third SPC layer comprise at least one halogen source.

In some embodiments of the article, the halogen reservoir comprises at least one permeation control material.

In some embodiments of the article, the halogen reservoir comprises 5 wt % to 95 wt % of the at least one permeation control material based on a total weight of the halogen reservoir; and 5 wt % to 50 wt % of at least one halogen source based on a total weight of the halogen reservoir.

In some embodiments, the article comprises a first permeation control material; and a second permeation control material, wherein the second permeation control material is in the form of at least two layers of the second permeation control material.

In some embodiments of the article, the at least one permeation control material comprises a first permeation control material; and a second permeation control material, wherein the second permeation control material is in the form of at least one layer of the second permeation control material, wherein the at least one layer of the second permeation control material is disposed between the first SPC layer and the halogen reservoir.

In some embodiments of the article, the at least one permeation control material comprises a first permeation control material; and a second permeation control material, wherein the second permeation control material is in the form of at least one layer of the second permeation control material, wherein the at least one layer of the second permeation control material is disposed between the second SPC layer and the halogen reservoir.

In some embodiments of the article, the at least one permeation control material comprises a first permeation control material; and a second permeation control material, wherein the second permeation control material is in the form of at least one layer of the second permeation control material, wherein the at least one layer of the second permeation control material is disposed between the first SPC layer and the halogen reservoir and also between the second SPC layer and the halogen reservoir.

In some embodiments of the article, the at least one layer of the second permeation control material comprises a first layer of the second permeation control material, wherein the first layer of the second permeation control material is disposed between the first SPC layer and the halogen reservoir; and a second layer of the second permeation control material, wherein the second layer of the second permeation control material is disposed between the second SPC layer and the halogen reservoir.

In some embodiments of the article, the halogen reservoir further comprises carbon particles.

In some embodiments of the article, the carbon particles are embedded within the at least one permeation control material.

Some such embodiments relate to flowing a flue gas stream over at least one surface of the article over a time period of at least 90 days, wherein the gas stream has a temperature of at least 20° C. and a relative humidity of at least 95%, wherein the gas stream comprises at least one SOₓ compound in a concentration of at least 1 ppm, and mercury vapor in a concentration of at least 1 μg/m³ based on a total volume of the flue gas stream.

In some embodiments, the article has a release rate of total halogens from the article that does not exceed 0.5% of the total halogens in the article per day, upon flowing a flue gas stream over at least one surface of the article over a time period of at least 90 days, wherein the flue gas stream has a temperature of at least 50° C. and a relative humidity of at least 95%, and wherein the flue gas stream comprises at least one SOₓ compound in a concentration of at least 20 ppm, and mercury vapor in a concentration of at least 1 μg/m³ of the flue gas stream.

In some embodiments, the article has a release rate of total halogens from the article that does not exceed 2% of the total halogens in the article per day, upon flowing a flue gas stream over at least one surface of the article over a time period of at least 90 days, wherein the flue gas stream has a temperature of at least 20° C. and a relative humidity of at least 95%, and wherein the flue gas stream comprises at least one SOₓ compound in a concentration of at least 1 ppm, and mercury vapor in a concentration of at least 1 μg/m³ of the flue gas stream.

In some embodiments, the article comprises a filter laminate, a layered filter material, an SPC laminate, or a layered SPC material.

In some embodiments, a method for forming an article comprises obtaining a first sorbent polymer composite (SPC) layer; obtaining a second SPC layer; obtaining a halogen reservoir; disposing the halogen reservoir between the first SPC layer and the second SPC layer so as to result in a layered structure; and adhering the layered structure together to form the article.

In some embodiments of the method, the disposing the halogen reservoir between the first SPC layer and the second SPC layer comprises disposing at least one permeation control layer between the first SPC layer and the halogen reservoir, disposing the at least one permeation control layer between the second SPC layer and the halogen reservoir, or both, such that the article formed comprises at least one permeation control layer.

In some embodiments of the method, the disposing the halogen reservoir between the first SPC layer and the second SPC layer comprises disposing a first layer of at least one permeation control material between the first SPC layer and the halogen reservoir; and disposing a second layer of the at least one permeation control material between the second SPC layer and the halogen reservoir.

In some embodiments, the method comprises or further comprises combining at least one halogen source with at least one permeation control material, so as to form the halogen reservoir, wherein the halogen reservoir comprises the at least one halogen source, and the at least one permeation control material.

In some embodiments of the method, the combining the at least one halogen source with the at least one permeation control material comprises heating the at least one permeation control material to a temperature sufficient to melt the at least one permeation control material; and mixing the at least one melted permeation control material with at least one halogen source.

In some embodiments of the method, the temperature sufficient to melt the at least one permeation control material ranges from 130° C. to 180° C.

In some embodiments of the method, the combining of the at least one halogen source with the at least one permeation control material comprises dissolving the at least one permeation control material in a solvent so as to form a mixture; adding at least one halogen source to the mixture of the solvent and the at least one permeation control material; and evaporating the solvent.

In some embodiments, the method comprises or further comprises adding particles to the mixture of the at least one halogen source, solvent, and the at least one permeation control material.

In some embodiments of the method, the particles are carbon particles.

In some embodiments of the method, the combining of the at least one halogen source with the at least one permeation control material comprises forming a chemical complex with the at least one halogen source and the at least one permeation control material.

In some embodiments of the method, the at least one halogen source is in a solution.

In some embodiments of the method, the at least one halogen source is in a gas phase.

In some embodiments of the method, the at least one halogen source is a salt.

In some embodiments of the method, the at least one halogen source is in a solution, in a gas phase, is a salt, or any combination thereof.

In some embodiments, a method comprises or further comprises flowing a flue gas stream over at least one surface of the article over a time period of at least 90 days, wherein the flue gas stream has a temperature of at least 50° C. and a relative humidity of at least 95%, wherein the flue gas stream comprises at least one SOₓ compound in a concentration of at least 20 ppm, and mercury vapor in a concentration of at least 1 μg/m³ based on a total volume of the flue gas stream, wherein a release rate of total halogens in the article does not exceed 0.5% of total halogens in the article per day during the flowing the flue gas stream.

In some embodiments, a method comprises or further comprises flowing a flue gas stream over at least one surface of the article over a time period of at least 90 days, wherein the flue gas stream has a temperature of at least 20° C. and a relative humidity of at least 95%, wherein the flue gas stream comprises at least one SOₓ compound in a concentration of at least 1 ppm, and mercury vapor in a concentration of at least 1 μg/m³ based on a total volume of the flue gas stream, wherein a release rate of total halogens in the article does not exceed 2% of total halogens in the article per day during the flowing the flue gas stream.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a non-limiting embodiment of the article described herein.

FIG. 2A depicts a non-limiting embodiment of the article described herein having a sorbent polymer composite as a halogen reservoir for at least one halogen source.

FIG. 2B depicts a further non-limiting embodiment of the article of FIG. 2A having, for example, two permeation control layers.

FIG. 3A depicts a non-limiting embodiment of the article described herein comprising a halogen reservoir, where the halogen reservoir comprises at least one permeation control material and at least one halogen source.

FIG. 3B depicts a further non-limiting embodiment of the article of FIG. 3A having a plurality of permeation control layers.

FIG. 3C depicts a further non-limiting embodiment of FIG. 3A where the halogen reservoir comprises particles.

FIG. 3D depicts a further non-limiting embodiment of FIG. 3C where the halogen reservoir comprises particles and further comprising two permeation control layers.

FIG. 4 depicts a non-limiting embodiment of a pollution control system having any of the article(s) described herein.

FIG. 5 depicts a non-limiting embodiment showing a flue gas flowing over a non-limiting embodiment of the article(s) described herein.

FIG. 6A depicts graphs of relative iodine content versus time, according to non-limiting embodiments represented in Article 1C and 1D of the examples.

FIG. 6B depicts graphs of relative iodine content versus time, according to non-limiting embodiments represented in Article 1A and 1B of the examples.

FIG. 7A depicts graphs of iodine content in wt % versus time, according to non-limiting embodiments represented in examples 2A and 2B.

FIG. 7B depicts graphs of iodine content in wt % versus time, according to non-limiting embodiments represented in examples 2C and 2D.

FIG. 8A depicts graphs of relative iodine content versus time, according to non-limiting embodiments represented in Article 3A and 3B of the examples.

FIG. 8B depicts graphs of relative iodine content versus time, according to non-limiting embodiments represented in Article 3C to 3G of the examples.

FIG. 8C is an EDX mapping of halogen content of a cross-section of Article 3B of the examples.

FIG. 8D is an EDX mapping of sulfur content of a cross-section of Article 3B of the examples.

FIG. 8E is an EDX mapping of halogen content of a cross-section of Article 3G of the examples.

FIG. 9 depicts graphs of relative iodine content versus time, according to non-limiting embodiments represented in Article 4A and Article 4B of the examples.

FIG. 10 is a graph of relative iodine content versus time, according to comparative examples 5A and 5B.

FIG. 11 is a graph of relative iodine content versus time, according to comparative examples 5A and 5B.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

All prior patents and publications referenced herein are incorporated by reference in their entireties.

An SPC has been proven to be particularly effective in removing undesirable components from a flue gas stream. Such undesirable components, may include, but are not limited to, at least one SOₓ compound and mercury vapor.

The use of at least one halogen source can enhance the removal efficiency of the SPC. However, in some cases, the at least one halogen source may not be sufficiently durable to allow for the SPC (and systems including the same, such as but not limited to, fixed bed absorbent systems) to remain in operation for multiple years. In some instances, this may occur because addition of the at least one halogen source may leach away from the sorbent.

As used herein, the term “removal efficiency” means the performance of a pollution control system in terms of the ratio of the amount of the regulated pollutant removed from the airstream (e.g., flue gas) to the total amount of regulated pollutant that enters the pollution control system. Accordingly, the “removal efficiency” for a particular pollutant means the percentage of that pollutant removed by the pollution control system. For example, the removal efficiency for NOX can be measured as the percent reduction in concentration of NOX achieved by a pollution control system. This percent reduction shall be calculated by subtracting an outlet concentration from an inlet concentration, dividing this difference by the inlet concentration, and then multiplying the result by 100.

Some embodiments of the present disclosure provide an exemplary solution whereby a halogen reservoir (e.g., in the form of a layer) allows the at least one halogen source to be released over time. The halogen reservoir can allow the SPC (and systems including the same, such as but not limited to, fixed bed absorbent systems) to operate (e.g., be in service) over a longer period of time as compared to an SPC that does not include a halogen reservoir.

As used herein, the term “sorbent” means a substance which has the property of collecting molecules of another substance by at least one of absorption, adsorption, or combinations thereof.

In some embodiments, an SPC includes a sorbent. In some embodiments, the sorbent of the SPC comprises activated carbon. In some embodiments, the sorbent comprises activated carbon derived from coal, lignite, wood, coconut shells, another carbonaceous material, or any combination thereof. In some embodiments, the sorbent can include silica gel, a zeolite, or any combination thereof.

As used herein, the term “composite” refers to a material including two or more constituent materials with different physical or chemical properties that, when combined, result in a material with characteristics different from the individual components.

As used herein, a “sorbent polymer composite” (SPC) is a composite that includes a sorbent and a polymer. The sorbent polymer composite material further includes a halogen source. In some embodiments, the halogen source may be incorporated into the sorbent polymer composite material by any suitable technique which may include, but is not limited to, imbibing, impregnating, adsorbing, mixing, sprinkling, spraying, dipping, painting, coating, ion exchanging or otherwise applying the halogen source to the sorbent polymer composite material. In some embodiments, the halogen source may be located within the sorbent polymer composite material, such as within any porosity of the sorbent polymer composite material. In some embodiments, the halogen source may be provided in a solution which may, under system operation conditions, in situ contact the sorbent polymer composite material. The halogen source of the sorbent polymer composite is a halogen salt, an elemental halogen, or any combination thereof. In some embodiments, the halogen source is chosen from at least one of sodium chloride, potassium chloride, sodium bromide, potassium bromide, sodium iodide, potassium iodide, tetramethylammonium iodide, tetrabutylammonium iodide, tetraethylammonium iodide, tetrapropylammonium iodide, tetramethylammonium bromide, tetraethylammonium bromide, tetrapropylammonium bromide, tetrabutylammonium bromide, tetramethylammonium chloride, tetraethylammonium chloride, tetrapropylammonium chloride, tetrabutylammonium chloride, elemental iodine (I₂), elemental chlorine (Cl₂), elemental bromine (Br₂), or any combination thereof.

Additional configurations of the sorbent polymer composite described herein and additional examples of the halogen sources described herein are set out in U.S. Pat. No. 9,827,551 (1368) to Hardwick et al and U.S. Pat. No. 7,442,352 to Lu et al., each of which are incorporated by reference herein in their entireties.

As used herein, the term “reservoir” refers to a repository that contains at least one material, whereby the repository is configured to release the at least one material over a period of time. In some non-limiting embodiments, the repository may comprise at least one permeation control material.

As used herein, the term “halogen reservoir” refers to a reservoir comprising at least one halogen source, where the at least one halogen source is configured to be released from the repository over a period of time. As used herein “halogen reservoir” and “reservoir” may be used interchangeably without altering the respective meaning of each term.

As used herein “embedded” means that a first material is distributed throughout a second material.

As used herein, the term “permeation control material” refers to a material that is configured to release one or more substances from the reservoir at a slower rate than the substance would have been released without the permeation control layer being present.

As used herein, the term “halogen source” refers to any chemical compound comprising at least one halide ion or an elemental halogen.

The halogen source of a flue gas treatment device is selected from tetrabutylammonium iodide, tetrabutylammonium tri-iodide, tetrabutylammonium tri-bromide, or tetrabutylammonium bromide. In another embodiment, the halogen source is a compound with a formula: N(R1R2R3R4)X, where N is nitrogen and X=I⁻, Br⁻, I₃⁻, BrI₂⁻, BrI₂⁻, Br₃⁻ and where R1, R2, R3 and R4 are selected from the group consisting of a hydrocarbon having from about 1 to about 18 carbon atoms where the hydrocarbon may be a simple alkyl, including but not limited to, linear or branched alkyl. The halogen source may comprise a tri-halide where the tri-halide is formed from its halide precursor by acid treatment in the presence of an oxidizer. In a further embodiment, the halogen source is a tri-halide where the tri-halide is formed from its halide precursor by acid treatment in the presence of an oxidizer selected from the group consisting of hydrogen peroxide, alkali metal persulfate, alkali metal monopersulfate, potassium iodate, potassium monopersulfates, oxygen, iron (III) salts, iron (III) nitrate iron (III) sulfate, iron (III) oxide and combinations thereof.

As used herein, “release rate of total halogens” is a release rate, from the article, into the external environment where the article is present, of the at least one halogen source. In some non-limiting embodiments, the external environment may be a flue gas stream. In some embodiments, the at least one halogen source is released solely from the SPC, into the external environment. In these embodiments, the “release rate of total halogens” is the release rate from the SPC into the external environment. In some embodiments, the at least one halogen source is released solely from the halogen reservoirs into the external environment. In these embodiments, the “release rate of total halogens” is the release rate from the halogen reservoirs into the external environment. In some embodiments, the at least one halogen source is released from a combination of the SPC and the halogen reservoirs into the external environment. In these embodiments, the “release rate of total halogens” is a combined release rate, which accounts for the release of the at least one halogen source from both the SPC and the halogen reservoirs. In some embodiments, the article comprises a plurality of halogen sources. In these embodiments, the “release rate of total halogens” is a combined release rate, which accounts for the release of all of the plurality of halogen sources in the article.

The determination of the release rate is further explained below.

As used herein, the term “carbon particle” refers to any particle comprising carbon.

As used herein, a “porous carbon particle” refers to carbon particle having pores, and does not include carbon particles without pores. That is, porous carbon particle excludes “non-porous” carbon particles.

As used herein, the term “flue gas stream” refers to a gaseous mixture that comprises at least one byproduct of a combustion process (such as, but not limited to, a coal combustion process). In some embodiments, a flue gas stream may consist entirely of byproducts of a combustion process. In some embodiments, a flue gas stream may include at least one gas in an elevated concentration relative to a concentration resulting from the combustion process. For instance, in one non-limiting example, a flue gas stream may be subjected to a “scrubbing” process during which water vapor may be added to the flue gas stream. Accordingly, in some such embodiments, the flue gas stream may include water vapor in an elevated concentration relative to the initial water vapor concentration due to combustion. Similarly, in some embodiments, a flue gas stream may include at least one gas in a lesser concentration relative to an initial concentration of the at least one gas output from the combustion process. This may occur, for example, by removing at least a portion at least one gas after combustion. In some embodiments, a flue gas stream may take the form of a gaseous mixture that is a combination of byproducts of multiple combustion processes.

As used herein, the term a “SOₓ compound” refers to any oxide of sulfur. In some nonlimiting embodiments, “SOₓ compound” may specifically refer to gaseous oxides of sulfur that are known environmental pollutants. Non-limiting examples of SOₓ compounds include sulfur dioxide (SO₂) and sulfur trioxide (SO₃). Additional non-limiting examples of SOₓ compounds include sulfur monoxide (SO), disulfur monoxide (S₂O), and disulfur dioxide (S₂O₂).

As used herein, the term “mercury vapor” refers to a gaseous compound comprising mercury. Nonlimiting examples of mercury vapor include elemental mercury vapor and oxidized mercury vapor.

As used herein, the term “oxidized mercury vapor” is defined as a vapor-phase mercury compound that includes mercury in a positive valence state. Non-limiting examples of oxidized mercury vapor include mercurous halides and mercuric halides.

Some embodiments of the present disclosure relate to an article comprising a first SPC layer, a second SPC layer, and a halogen reservoir. In some embodiments the halogen reservoir includes at least one halogen source. In some embodiments, the halogen reservoir is disposed between the first SPC layer and the second SPC layer.

In some embodiments, the thickness of the at least one of the first SPC layer or the second SPC layer may be measured using cross section scanning electron microscopy. In some embodiments, at least one of the first SPC layer or the second SPC layer has a thickness ranging from 0.2 mm to 2 mm, from 0.4 mm to 2 mm, from 0.8 mm to 2 mm, from 1.2 mm to 2 mm or from 1.6 mm to 2 mm

In some embodiments, at least one of the first SPC layer or the second SPC layer has a thickness ranging from 0.2 mm to 1.6 mm, from 0.2 mm to 1.2 mm, from 0.2 mm to 0.8 mm or from 0.2 mm to 0.4 mm.

In some embodiments, at least one of the first SPC layer or the second SPC layer has a thickness ranging from 0.4 mm to 1.6 mm or from 0.8 mm to 1.2 mm

In some embodiments, the SPC can include one or more homopolymers, copolymers or terpolymers containing at least one fluoromonomer with or without additional non-fluorinated monomers.

In some embodiments, the article comprises a first SPC. In some embodiments, the article comprises a first sorbent and a first polymer material. In some embodiments, the article comprises a second SPC. In some embodiments, the article comprises a second sorbent and a second polymer material. In some embodiments, the first sorbent and the second sorbent comprise the same material. In some embodiments, the first sorbent and the second sorbent comprise different materials. In some embodiments, the first polymer material and the second polymer material comprise the same material. In some embodiments, the first polymer material and the second polymer material comprise different materials.

In some embodiments, at least one of the first sorbent or the second sorbent comprises activated carbon, silica gel, zeolite, or a combination thereof.

In some embodiments, the polymer material of the SPC can include at least one of: polyfluoroethylene propylene (PFEP); polyperfluoroacrylate (PPFA); polyvinylidene fluoride (PVDF); a terpolymer of tetrafluoroethylene, hexafluoropropylene and vinylidene fluoride (THV); polychlorotrifluoro ethylene (PCFE); poly(ethylene-co-tetrafluorethylene) (ETFE); ultrahigh molecular weight polyethylene (UHMWPE); polyethylene; polyparaxylylene (PPX); polyactic acid (PLLA); polyethylene (PE); expanded polyethylene (ePE); polytetrafluoroethylene (PTFE); expanded polytetrafluoroethylene (ePTFE); or any combination thereof.

In some embodiments, the polymer material of the SPC can include polyvinylidene fluoride (PVDF). In some embodiments, the PVDF may be a PVDF homopolymer. In some embodiments, the PVDF may be a PVDF copolymer. In some embodiments, the PVDF copolymer is a copolymer of PVDF and hexafluoropropylene (HFP). Non-limiting commercial examples of PVDF homopolymers or copolymers that may be suitable for some embodiments of the present disclosure, include but are not limited to Kynar Flex® and Kynar Superflex®, each of which is commercially available from the company Arkema.

In some embodiments, the polymer material of the SPC can include polytetrafluoroethylene (PTFE). In some embodiments, the polymer is expanded polytetrafluoroethylene (ePTFE). In some embodiments, the structure of the polymer can become porous upon stretching, such that voids can form between fibrils and nodes of the polymer.

In some embodiments, the polymer of the SPC has a surface energy of less than 31 dynes per cm, less than 30 dynes per cm, less than 25 dynes per cm, less than 20 dynes per cm or less than 15 dynes per cm.

In some embodiments, the polymer of the SPC has a surface energy ranging from 15 dynes per cm to 31 dynes per cm, from 20 dynes per cm to 31 dynes per cm, from 25 dynes per cm to 31 dynes per cm or from 30 dynes per cm to 31 dynes per cm

In some embodiments, the polymer of the SPC has a surface energy ranging from 15 dynes per cm to 30 dynes per cm, from 15 dynes per cm to 25 dynes per cm or from 15 dynes per cm to 20 dynes per cm.

In some embodiments, the polymer of the SPC has a surface energy ranging from 20 dynes per cm to 25 dynes per cm.

In some embodiments, the sorbent material of the SPC comprises activated carbon. In some embodiments, the activated carbon material derived from one or more of coal, lignite, wood, coconut shells or another carbonaceous material. In some embodiments, the sorbent material can include silica gel or a zeolite.

In some embodiments, the sorbent of the SPC has a surface area in excess of 400 m²/g, in excess of 600 m²/g, in excess of 800 m²/g, in excess of 1000 m²/g, in excess of 1200 m²/g, in excess of 1400 m²/g, in excess of 1600 m²/g, in excess of 1800 m²/g or in excess of 2000 m²/g.

In some embodiments, the sorbent of the SPC has a surface area ranging from 400 m²/g to 2000 m²/g, from 600 m²/g to 2000 m²/g, from 800 m²/g to 2000 m²/g, from 1000 m²/g to 2000 m²/g, from 1200 m²/g to 2000 m²/g, from 1400 m²/g to 2000 m²/g, from 1600 m²/g to 2000 m²/g or from 1800 m²/g to 2000 m²/g.

In some embodiments, the sorbent of the SPC has a surface area ranging from 400 m²/g to 1800 m²/g, from 400 m²/g to 1600 m²/g, from 400 m²/g to 1400 m²/g, from 400 m²/g to 1200 m²/g, from 400 m²/g to 1000 m²/g, from 400 m²/g to 800 m²/g or from 400 m²/g to 600 m²/g.

In some embodiments, the sorbent of the SPC has a surface area ranging from 600 m²/g to 1800 m²/g, from 800 m²/g to 1600 m²/g or from 1000 m²/g to 1400 m²/g.

In some embodiments, the first SPC layer and the second SPC layer comprise the same composition. In some embodiments, the first SPC layer and the second SPC layer comprise different compositions.

In some embodiments, the at least one permeation control material has a sufficient thickness, so as to result in a release rate constant of total halogens from the article that does not exceed a specified amount of total halogens per day, under conditions where a flue gas stream is flowed over at least one surface of the article over a time period of at least 90 days.

In some embodiments, the flue gas stream is flowed over at least one surface of the article over a time period of at least 100 days, of at least 200 days, of at least 300 days, of at least 400 days, of at least 500 days, of at least 600 days, of at least 700 days, of at least 800 days, of at least 900 days, of at least 1,000 days, of at least 2,000 days, of at least 3,000 days, of at least 4,000 days or of at least 5,000 days.

In some embodiments, the flue gas stream is flowed over at least one surface of the article over a time period of 100 days to 10,000 days, over a time period of 500 days to 10,000 days, over a time period of 1,000 days to 10,000 days or over a time period of 5,000 days to 10,000 days.

In some embodiments, the flue gas stream is flowed over at least one surface of the article over a time period of 100 days to 5,000 days, over a time period of 100 days to 1,000 days or over a time period of 100 days to 500 days

In some embodiments, the flue gas stream is flowed over at least one surface of the article over a time period of 500 days to 10,000 days or over a time period of 1,000 days to 5,000 days.

Non-limiting examples of numerical values for “the sufficient thickness of the at least one permeation control material” are described herein. In some non-limiting embodiments where the at least one permeation control material forms a part of the halogen reservoir, the sufficient thickness of the at least one permeation control material may be considered equivalent to the thickness of the halogen reservoir.

In some non-limiting embodiments where the at least one permeation control material takes the form of at least one permeation control layer, the sufficient thickness of the at least one permeation control material may be considered equivalent to the thickness of a single permeation control layer (in embodiments where only a single permeation control layer is present) or a sum of thicknesses of multiple permeation control layers (in embodiments where multiple permeation control layers are present).

In some embodiments, the at least one permeation control material has a sufficient thickness, so as to result in a release rate of total halogens from the article that does not exceed 0.5% total halogens per day, when a flue gas stream is flowed over at least one surface of the article over a time period of at least 90 days, wherein the flue gas stream has a temperature of at least 50° C. and a relative humidity of at least 95%, and wherein the gas stream comprises at least one SOₓ compound in a concentration of at least 20 ppm, and mercury vapor in a concentration of at least 1 μg/m³ of the flue gas stream.

In some embodiments, the at least one permeation control material has a sufficient thickness, so as to result in a release rate constant of total halogens from the article that does not exceed 2% total halogens per day, when a flue gas stream is flowed over at least one surface of the article over a time period of at least 90 days, wherein the flue gas stream has a temperature of at least 20° C. and a relative humidity of at least 95%, and wherein the gas stream comprises at least one SOₓ compound in a concentration of at least 1 ppm, and mercury vapor in a concentration of at least 1 μg/m³ of the flue gas stream.

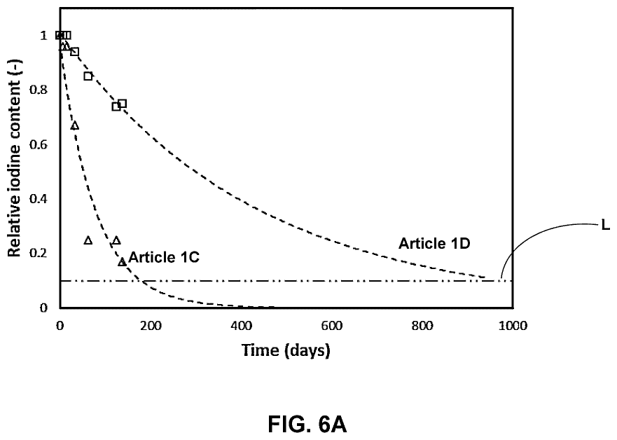

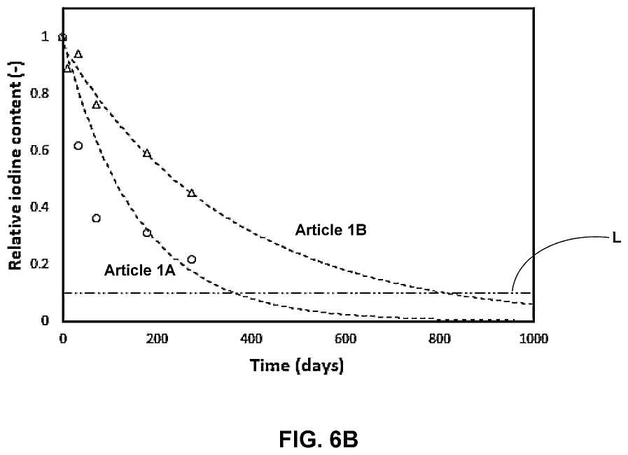

In some embodiments, the release rate in % refers to the relative amount of halogen over time, not relative to the weight of the SPC. In some embodiments, the decrease of the iodine content (or release rate) is exponential (i.e., the decrease can be described to be an exponential decay), as shown, for example, in FIGS. 6A and 6B, as discussed further herein. Accordingly, a constant “k” can be used to describe this behavior, wherein “k” can be called a “release rate constant,” a “decay constant,” or an “exponential decay constant.”

In some embodiments, the flue gas stream has a temperature greater than 20° C., greater than 30° C., greater than 40° C., greater than 50° C., greater than 60° C., greater than 60° C., greater than 70° C., greater than 75° C., greater than 80° C., greater than 85° C. or greater than 90° C.

In some embodiments, the flue gas stream has a temperature less than 20° C., less than 30° C., less than 40° C., less than 50° C., less than 60° C., less than 70° C., less than 75° C., less than 80° C., less than 85° C. or less than 90° C.

In some embodiments, the flue gas stream has a temperature from 20° C. to 80° C., from 30° C. to 80° C., from 40° C. to 80° C., from 50° C. to 80° C., from 60° C. to 80° C. or from 70° C. to 80° C.

In some embodiments, the flue gas stream has a temperature from 20° C. to 70° C., from 20° C. to 60° C., from 20° C. to 50° C., from 20° C. to 40° C. or from 20° C. to 30° C.

In some embodiments, the flue gas stream has a temperature from 30° C. to 70° C. or from 40° C. to 60° C.

In some embodiments, the flue gas stream has a temperature from 50° C. to 70° C., from 60° C. to 70° C., from 55° C. to 70° C. or from 55° C. to 60° C.

In some embodiments, the flue gas stream has a temperature of from 65° C. to 70° C., from 70° C. to 75° C., from 75° C. to 80° C., from 80° C. to 85° C. or from 85° C. to 90° C.

In some embodiments, the flue gas stream has a temperature of from 65° C. to 90° C., from 70° C. to 90° C., from 75° C. to 90° C., from 80° C. to 90° C. or from 85° C. to 90° C.

In some embodiments, the flue gas stream has a temperature of from 65° C. to 75° C., from 65° C. to 80° C., from 65° C. to 85° C. or from 65° C. to 90° C. The temperature of the flue gas stream may be measured using a thermometer as known by the skilled person in the art.

In some embodiments, the flue gas stream has a relative humidity of at least 95%, of at least 96%, of at least 97%, of at least 98%, of at least 99% or of 100%.

In some embodiments, the flue gas stream has a relative humidity of from 95% to 100%, from 96% to 100%, from 97% to 100%, from 98% to 100% or from 99% to 100.

In some embodiments, the flue gas stream has a relative humidity of from 95% to 96%, from 95% to 97%, from 95% to 98%, from 95% to 99% or from 95% to 100%.

In some embodiments, the flue gas stream does not comprise at least one SOₓ compound.

In some embodiments, the flue gas stream comprises at least one SOₓ compound in a concentration of at least 1 ppm, of at least 5 ppm, of at least 10 ppm, of at least 20 ppm, of at least 25 ppm, of at least 30 ppm, of at least 35 ppm, of at least 40 ppm, of at least 45 ppm, of at least 50 ppm, of at least 100 ppm, of at least 300 ppm, of at least 500 ppm, or of at least 1000 ppm.

In some embodiments, the flue gas stream comprises at least one SOₓ compound in a concentration of from 1 ppm to 200 ppm, from 5 ppm to 200 ppm, from 10 ppm to 200 ppm, from 50 ppm to 200 ppm, or from 100 ppm to 200 ppm.

In some embodiments, the flue gas stream comprises at least one SOₓ compound in a concentration of from 20 ppm to 100 ppm, from 25 ppm to 100 ppm, from 30 ppm to 100 ppm, from 35 ppm to 100 ppm, from 40 ppm to 100 ppm, from 45 ppm to 100 ppm, from 50 ppm to 100 ppm, from 55 ppm to 100 ppm, from 60 ppm to 100 ppm, from 65 ppm to 100 ppm, from 70 ppm to 100 ppm, from 75 ppm to 100 ppm, from 80 ppm to 100 ppm, from 85 ppm to 100 ppm, from 90 ppm to 100 ppm, or from 95 ppm to 100 ppm.

In some embodiments, the flue gas stream comprises at least one SOₓ compound in a concentration of from 20 ppm to 25 ppm, from 20 ppm to 30 ppm, from 20 ppm to 35 ppm, from 20 ppm to 40 ppm, from 20 ppm to 45 ppm, from 20 ppm to 50 ppm, from 20 ppm to 55 ppm, from 20 ppm to 60 ppm, from 20 ppm to 65 ppm, from 20 ppm to 70 ppm, from 20 ppm to 75 ppm, from 20 ppm to 80 ppm, from 20 ppm to 85 ppm, from 20 ppm to 90 ppm, from 20 ppm to 95 ppm or from 20 ppm to 100 ppm.

In some embodiments, the flue gas stream comprises at least one SOₓ compound in a concentration of from 1 ppm to 90 ppm, from 1 ppm to 80 ppm, from 1 ppm to 70 ppm, from 1 ppm to 90 ppm, from 1 ppm to 90 ppm, from 1 ppm to 60 ppm, from 1 ppm to 50 ppm, from 1 ppm to 40 ppm, from 1 ppm to 30 ppm, from 1 ppm to 20 ppm, from 1 ppm to 10 ppm or from 1 ppm to 5 ppm.

In some embodiments, the flue gas stream does not comprise mercury vapor.

In some embodiments, the flue gas stream comprises mercury vapor in a concentration of at least 1 μg/m³ of the flue gas stream, of at least 2 μg/m³ of the flue gas stream, of at least 3 μg/m³ of the flue gas stream, of at least 4 μg/m³ of the flue gas stream, of at least 5 μg/m³ of the flue gas stream, of at least 6 μg/m³ of the flue gas stream, of at least 7 μg/m³ of the flue gas stream, of at least 8 μg/m³ of the flue gas stream, of at least 9 μg/m³ of the flue gas stream, of at least 10 μg/m³ of the flue gas stream, of at least 15 μg/m³ of the flue gas stream, of at least 20 μg/m³ of the flue gas stream or of at least 50 μg/m³ of the flue gas stream.

In some embodiments the flue gas stream comprises mercury vapor in a concentration of from 1 μg/m³ to 50 μg/m³ of the flue gas stream, from 5 μg/m³ to 50 μg/m³ of the flue gas stream, from 10 μg/m³ to 50 μg/m³ of the flue gas stream, from 20 μg/m³ to 50 μg/m³ of the flue gas stream or from 40 μg/m³ to 50 μg/m³ of the flue gas stream.

In some embodiments, the flue gas stream comprises mercury vapor in a concentration of from 1 μg/m³ to 10 μg/m³ of the flue gas stream, from 2 μg/m³ to 10 μg/m³ of the flue gas stream, from 3 μg/m³ to 10 μg/m³ of the flue gas stream, from 4 μg/m³ to 10 μg/m³ of the flue gas stream, from 5 μg/m³ to 10 μg/m³ of the flue gas stream, from 6 μg/m³ to 10 μg/m³ of the flue gas stream, from 7 μg/m³ to 10 μg/m³ of the flue gas stream, from 8 μg/m³ to 10 μg/m³ of the flue gas stream or from 9 μg/m³ to 10 μg/m³ of the flue gas stream.

In some embodiments, the flue gas stream comprises mercury vapor in a concentration of from 1 μg/m³ to 2 μg/m³ of the flue gas stream, from 1 μg/m³ to 3 μg/m³ of the flue gas stream, from 1 μg/m³ and 4 μg/m³ of the flue gas stream, from 1 μg/m³ and 5 μg/m³ of the flue gas stream, from 1 μg/m³ to 6 μg/m³ of the flue gas stream, from 1 μg/m³ to 7 μg/m³ of the flue gas stream, from 1 μg/m³ to 8 μg/m³ of the flue gas stream or from 1 μg/m³ to 9 μg/m³ of the flue gas stream.

In some embodiments, the at least one permeation control material comprises polycarbonate (PC), ethyl cellulose (EC), polystyrene (PS), polystyrene-divinylbenzene (PS-DVB), polyacrylonitrile (PAN), polyvinylidene chloride (PVDC), polyvinylidene fluoride (PVDF), polyvinylidene fluoride copolymers with perfluoropropylene, polyethylene terephthalate (PET), polyethylene naphthalate (PEN), polychlorotrifluoroethylene (PCTFE), cross-linked epoxy, or any combination thereof. In some embodiments, the at least one permeation control material comprises polyvinyl chloride (PVC), chlorinated polyvinyl chloride (CPVC), at least one polyolefin, or any combination thereof. In some embodiments, the at least one polyolefin comprises polyethylene (including but not limited to ultra-high-molecular weight (UHMW) polyethylene), polypropylene, polybutylene, or any combination thereof.

In some embodiments, the PVDF copolymer is a copolymer of PVDF and hexafluoropropylene (HFP).

Non-limiting commercial examples of PVDF homopolymers or copolymers that may be suitable for some embodiments of the present disclosure, include but are not limited to Kynar Flex® and Kynar Superflex®, each of which is commercially available from the company Arkema.

In some embodiments, the permeation control material may take the form of adhesive layer, a discontinuous film like a netting, a continuous film, or any combination thereof. In some embodiments the permeation control material is an adhesive layer. In some embodiments, the permeation control material is a PVDF adhesive layer in the form of a netting, such as the non-limiting example described in Example 1 below. In some embodiments, the permeation control material is a PVDF adhesive layer in the form of a continuous film, such as the non-limiting example described in Example 1 below.

In some embodiments, the at least one permeation control material is in the form of at least one permeation control layer, wherein the at least one permeation control layer is disposed between the first SPC layer and the halogen reservoir, between the second SPC layer and the halogen reservoir, or both.

In some embodiments, the article further comprises from 1 to 20 permeation control layers, wherein the permeation control layers are disposed between the SPC layers and the halogen reservoir.

In some embodiments, the article further comprises 1 permeation control layer, wherein the permeation control layer is disposed between the SPC layer and the halogen reservoir. In some embodiments, the article further comprises 2 permeation control layers, 3 permeation control layers, 4 permeation control layers, 5 permeation control layers, 6 permeation control layers, 7 permeation control layers, 8 permeation control layers, 9 permeation control layers, 10 permeation control layers, 15 permeation control layers or 20 permeation control layers, wherein the permeation control layers are disposed between the SPC layers and the halogen reservoir.

In some embodiments, the article further comprises from 1 to 15 permeation control layers, from 1 to 10 permeation control layers, from 1 to 9 permeation control layers, from 1 to 8 permeation control layers, from 1 to 7 permeation control layers, from 1 to 6 permeation control layers, from 1 to 5 permeation control layers, from 1 to 4 permeation control layers, from 1 to 3 permeation control layers or from 1 to 2 permeation control layers, wherein the permeation control layers are disposed between the SPC layers and the halogen reservoir.

In some embodiments, the article further comprises from 2 to 20 permeation control layers, from 3 to 20 permeation control layers, from 4 to 20 permeation control layers, from 5 to 20 permeation control layers, from 6 to 20 permeation control layers, from 7 to 20 permeation control layers, from 8 to 20 permeation control layers, from 9 to 20 permeation control layers, from 10 to 20 permeation control layers or from 15 to 20 permeation control layers.

In some embodiments, the halogen reservoir comprises the at least one permeation control material and the at least one halogen source. In some embodiments, the at least one halogen source and the at least one permeation control material are present within the halogen reservoir. In some embodiments, the at least one halogen source and the at least one permeation control material form integral parts of the halogen reservoir. In some embodiments, the halogen reservoir consists essentially of the at least one permeation control material and the at least one halogen source. In some embodiments, the halogen reservoir consists of the at least one permeation control material and the at least one halogen source.

In some embodiments, the halogen reservoir is a third SPC layer. In some embodiments, the halogen reservoir comprises at least one permeation control material.

In some embodiments, the halogen reservoir comprises 5 wt % to 95 wt % of at least one permeation control material based on a total weight of the halogen reservoir.

In some embodiments, the halogen reservoir comprises 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt % or 95 wt % of at least one permeation control material based on a total weight of the halogen reservoir.

In some embodiments, the halogen reservoir comprises 10 wt % to 95 wt %, 15 wt % to 95 wt %, 20 wt % to 95 wt %, 25 wt % to 95 wt %, 30 wt % to 95 wt %, 35 wt % to 95 wt %, 40 wt % to 95 wt %, 45 wt % to 95 wt %, 50 wt % to 95 wt %, 55 wt % to 95 wt %, 60 wt % to 95 wt %, 65 wt % to 95 wt, 70 wt % to 95 wt %, 75 wt % to 95 wt, 80 wt % to 95 wt %, 85 wt % to 95 wt % or 90 wt % to 95 wt % of at least one permeation control material based on a total weight of the halogen reservoir.

In some embodiments, the halogen reservoir comprises 5 wt % to 10 wt %, 5 wt % to 15 wt %, 5 wt % to 20 wt %, 5 wt % to 25 wt %, 5 wt % to 30 wt %, 5 wt % to 35 wt %, 5 wt % to 40 wt %, 5 wt % to 45 wt %, 5 wt % to 50 wt %, 5 wt % to 55 wt %, 5 wt % to 60 wt %, 5 wt % to 65 wt %, 5 wt % to 70 wt %, 5 wt % to 75 wt %, 5 wt % to 80 wt %, 5 wt % to 85 wt % or 5 wt % to 90 wt % of at least one permeation control material based on a total weight of the halogen reservoir.

In some embodiments, the halogen reservoir comprises at least one halogen source based on a total weight of the halogen reservoir. In some embodiments, the halogen reservoir comprises 0.1 wt % to 50 wt % of at least one halogen source based on a total weight of the halogen reservoir.

In some embodiments, the halogen reservoir comprises 0.1 wt %, 0.2 wt %, 0.3 wt %, 0.4 wt % or 0.5 wt % of at least one halogen source based on a total weight of the halogen reservoir. In some embodiments, the halogen reservoir comprises 1 wt %, 2 wt %, 3 wt %, 4 wt % or 5 wt % of at least one halogen source based on a total weight of the halogen reservoir. In some embodiments, the halogen reservoir comprises 10 wt %, 15 wt %, 20 wt %, 25 wt %, 30 wt %, 35 wt %, 40 wt %, 45 wt % or 50 wt % of at least one halogen source based on a total weight of the halogen reservoir.

In some embodiments, the halogen reservoir comprises 0.1 wt % to 50 wt %, 0.2 wt % to 50 wt %, 0.3 wt % to 50 wt %, 0.4 wt % to 50 wt %, 0.5 wt % to 50 wt %, 1 wt % to 50 wt %, 2 wt % to 50 wt %, 3 wt % to 50 wt %, 4 wt % to 50 wt %, 5 wt % to 50 wt %, 10 wt % to 50 wt %, 15 wt % to 50 wt %, 20 wt % to 50 wt %, 25 wt % to 50 wt, 30 wt % to 50 wt %, 35 wt % to 50 wt %, 40 wt % to 50 wt % or 45 wt % to 50 wt % of at least one halogen source based on a total weight of the halogen reservoir.

In some embodiments, the halogen reservoir comprises 0.1 wt % to 45 wt %, 0.1 wt % to 40 wt %, 0.1 wt % to 35 wt %, 0.1 wt % to 30 wt %, 0.1 wt % to 25 wt %, 0.1 wt % to 20 wt %, 0.1 wt % to 15 wt %, 0.1 wt % to 10 wt %, 0.1 wt % to 5 wt %, 0.1 wt % to 1 wt %, 0.1 wt % to 0.5 wt %, 0.1 wt % to 0.4 wt %, 0.1 wt % to 0.3 wt % or 0.1 wt % to 0.2 wt % of at least one halogen source based a total weight of the halogen reservoir.

In some embodiments, the at least one halogen source comprises a metal halide, an ammonium halide, an elemental halogen, or any combination thereof. In some embodiments, the at least one halogen source comprises a metal halide. In some embodiments, the at least one halogen source is chosen from at least one of sodium chloride, potassium chloride, sodium bromide, potassium bromide, sodium iodide, or potassium iodide. In some embodiments, the at least one halogen source comprises an ammonium halide. In some embodiments, the at least one halogen source is chosen from at least one of tetramethylammonium iodide, tetrabutylammonium iodide, tetraethylammonium iodide, tetrapropylammonium iodide, tetramethylammonium bromide, tetraethylammonium bromide, tetrapropylammonium bromide, tetrabutylammonium bromide, tetramethylammonium chloride, tetraethylammonium chloride, tetrapropylammonium chloride, or tetrabutylammonium chloride, tetrabutylammonium tri-iodide, tetrabutylammonium tri-bromide, or any combination thereof. In some embodiments, the at least one halogen source comprises elemental halogen. In some embodiments, the at least one halogen source is chosen from at least one of elemental iodine (I₂), elemental chlorine (Cl₂), or elemental bromine (Br₂).

In some embodiments, the at least one halogen source is elemental iodine (I₂). In some embodiments, the at least one halogen source is tetrabutylammonium iodide (TBAI). In some embodiments, the at least one halogen source is potassium iodide (KI).

In some embodiments, the at least one halogen source comprises at least one phosphonium halide. In some embodiments, the at least one phosphonium halide comprises tetrabutylphosphonium iodide (TBPI), ethyltriphenylphosphonium triiodide (ETPPI3), tetrabutylphosphonium bromide (TBPBr), ethyltriphenylphosphonium bromide (ETPPBr), ethyltriphenylphosphonium iodide (ETPPI), or any combination thereof. In some embodiments, the at least one phosphonium halide is selected from the group consisting of tetrabutylphosphonium iodide (TBPI), ethyltriphenylphosphonium triiodide (ETPPI3), tetrabutylphosphonium bromide (TBPBr), ethyltriphenylphosphonium bromide (ETPPBr), ethyltriphenylphosphonium iodide (ETPPI), and any combination thereof.

In some embodiments, the at least one phosphonium halide comprises tetrabutylphosphonium iodide (TBPI), ethyltriphenylphosphonium triiodide (ETPPI3), tetrabutylphosphonium bromide (TBPBr), ethyltriphenylphosphonium bromide (ETPPBr), or any combination thereof. In some embodiments, the at least one phosphonium halide is selected from the group consisting of tetrabutylphosphonium iodide (TBPI), ethyltriphenylphosphonium triiodide (ETPPI3), tetrabutylphosphonium bromide (TBPBr), ethyltriphenylphosphonium bromide (ETPPBr), and any combination thereof.

In some embodiments, the at least one phosphonium halide is ethyltriphenylphosphonium iodide (ETPPI).

In some embodiments, the at least one halogen source may be incorporated into the SPC by any suitable technique which may include, but is not limited to, imbibing, impregnating, adsorbing, mixing, sprinkling, spraying, dipping, painting, coating, ion exchanging or otherwise applying the at least one halogen source to the SPC. In some embodiments, the at least one halogen source may be located within the SPC, such as within any porosity of the SPC. In some embodiments, the at least one halogen source may be provided in a solution which may, under system operation conditions, in situ contact the SPC.

Additional configurations of the sorbent polymer composite material described herein are set out in U.S. Pat. No. 9,827,551 to Hardwick et al. and U.S. Pat. No. 7,442,352 to Lu et al., each of which are incorporated by reference herein in their entireties.

In some embodiments, the halogen reservoir is configured to release the at least one halogen source into at least one of the first or second SPC layers at a rate of 0.01% to 0.3% of total halogens/day.

In some embodiments, the halogen reservoir is configured to release the at least one halogen source into at least one of the first or second SPC layers at a rate of 0.01%, of 0.02% or of 0.05% of total halogens/day. In some embodiments, the halogen reservoir is configured to release the at least one halogen source into at least one of the first or second SPC layers at a rate of 0.1%, of 0.2% or of 0.3% of total halogens/day.

In some embodiments, the halogen reservoir is configured to release the at least one halogen source into at least one of the first or second SPC layers at a rate of 0.01% to 0.2%, at a rate of 0.01% to 0.1%, at a rate of 0.01% to 0.05% or at a rate of 0.01% to 0.02% of total halogens/day.

In some embodiments, the halogen reservoir is configured to release the at least one halogen source into at least one of the first or second SPC layers at a rate of 0.02% to 0.3%, at a rate of 0.05% to 0.3%, at a rate of 0.1% to 0.3% or at a rate of 0.2% to 0.3% of total halogens/day.

In some embodiments at least one of the first SPC layer or the second SPC layer can also comprise at least one halogen source.

In some embodiments, the at least one halogen source of the first SPC layer or the at least one halogen source of second SPC layer, or both, is the same as the at least one halogen source of the halogen reservoir. In some embodiments, the at least one halogen source within the first SPC layer or the at least one halogen source within the second SPC layer is different from the at least one halogen source of the halogen reservoir.

In some embodiments, the at least one halogen source may be releasably bound to at least one polymer chain of the at least one permeation control material. In some embodiments, “releasably bound” means that the at least one halogen source may have a specific binding affinity (binding sorption capacity) to the at least one permeation control material. In some embodiments, this binding efficiency is a sufficient binding efficiency to result in any release rate, or range thereof, of the at least one halogen source from the at least one permeation control material described herein. In some embodiments, the at least one halogen source may become bound to the at least one permeation control material through solution diffusion.

In some embodiments, a binding sorption capacity between the at least one permeation control material and the at least one halogen source ranges from 5% to 50% by weight, from 10% to 50% by weight, from 25% to 50% by weight or from 45% to 50% by weight.

In some embodiments, a binding sorption capacity between the at least one permeation control material and the at least one halogen source ranges from 5% to 45% by weight, from 5% to 25% by weight or from 5% to 10% by weight.

In some embodiments, a binding sorption capacity between the at least one permeation control material and the at least one halogen source ranges from 10% to 45% by weight, from 10% to 25% by weight or from 25% to 45% by weight.

The binding sorption capacity may be determined by a gravimetric capacity test.

In some embodiments, the halogen reservoir further comprises particles embedded within the halogen reservoir.

The particles may comprise any suitable material. For example, in some embodiments the particles may comprise activated carbon derived from coal, lignite, wood, coconut shells, another carbonaceous material, a silica gel, a zeolite, or any combination thereof.

In some embodiments, the particles comprise carbon particles. In some embodiments, the carbon particles may comprise any type of carbon particle (e.g., activated carbon derived from coal, wood) listed herein.

In some embodiments, the particles are present in the halogen reservoir, the permeation control material, or any combination thereof in an amount from 1 wt % to 75 wt % based on a total weight of the halogen reservoir, the permeation control material, or any combination thereof. In some embodiments, the particles are present in the halogen reservoir, the permeation control material, or any combination thereof in an amount from 25 wt % to 75 wt % based on a total weight of the halogen reservoir, the permeation control material, or any combination thereof. In some embodiments, the particles are present in the halogen reservoir, the permeation control material, or any combination thereof in an amount from 50 wt % to 75 wt % based on a total weight of the halogen reservoir, the permeation control material, or any combination thereof.

In some embodiments, the particles are present in the halogen reservoir, the permeation control material, or any combination thereof in an amount from 1 wt % to 50 wt % based on a total weight of the halogen reservoir, the permeation control material, or any combination thereof. In some embodiments, the particles are present in the halogen reservoir, the permeation control material, or any combination thereof in an amount from 1 wt % to 25 wt % based on a total weight of the halogen reservoir, the permeation control material, or any combination thereof.

In some embodiments, the particles are present in the halogen reservoir, the permeation control material, or any combination thereof in an amount from 25 wt % to 50 wt % based on a total weight of the halogen reservoir, the permeation control material, or any combination thereof.

In some embodiments where the particles comprise activated carbon, the activated carbon is present in the halogen reservoir in an amount ranging from 0.1 wt % to 60 wt % based on the total weight of the halogen reservoir.

In some embodiments, the activated carbon is present in the halogen reservoir in an amount of 0.1 wt %, of 0.2 wt %, of 0.3 wt %, of 0.4 wt %, of 0.5 wt %, of 0.6 wt %, of 0.7 wt %, of 0.8 wt % or of 0.9 wt % based on the total weight of the halogen reservoir. In some embodiments, the activated carbon is present in the halogen reservoir in an amount of 1 wt %, of 5 wt %, of 10 wt %, of 15 wt %, of 20 wt %, of 25 wt %, of 30 wt %, of 35 wt %, of 40 wt %, of 45 wt %, of 50 wt %, of 55 wt % or of 60 wt %, based on the total weight of the halogen reservoir.

In some embodiments, the activated carbon is present in the halogen reservoir in an amount ranging from 0.2 wt % to 60 wt %, from 0.3 wt % to 60 wt %, from 0.4 wt % to 60 wt %, from 0.5 wt % to 60 wt %, from 0.6 wt % to 60 wt %, from 0.7 wt % to 60 wt %, from 0.8 wt % to 60 wt % or from 0.9 wt % to 60 wt % based on the total weight of the halogen reservoir. In some embodiments, the activated carbon is present in the halogen reservoir in an amount ranging from 1 wt % to 60 wt %, from 5 wt % to 60 wt %, from 10 wt % to 60 wt %, from 15 wt % to 60 wt %, from 20 wt % to 60 wt %, from 25 wt % to 60 wt %, from 30 wt % to 60 wt %, from 35 wt % to 60 wt %, from 40 wt % to 60 wt %, from 45 wt % to 60 wt %, from 50 wt % to 60 wt % or from 55 wt % to 60 wt % based on the total weight of the halogen reservoir.

In some embodiments, the activated carbon is present in the halogen reservoir in an amount ranging from 0.1 wt % to 55 wt %, from 0.1 wt % to 50 wt %, from 0.1 wt % to 45 wt %, from 0.1 wt % to 40 wt %, from 0.1 wt % to 35 wt %, from 0.1 wt % to 30 wt %, from 0.1 wt % to 25 wt %, from 0.1 wt % to 20 wt %, from 0.1 wt % to 15 wt %, from 0.1 wt % to 10 wt %, from 0.1 wt % to 5 wt %, from 0.1 wt % to 1 wt %, from 0.1 wt % to 0.9 wt %, from 0.1 wt % to 0.8 wt %, from 0.1 wt % to 0.7 wt %, from 0.1 wt % to 0.6 wt %, from 0.1 wt % to 0.5 wt %, from 0.1 wt % to 0.4 wt %, from 0.1 wt % to 0.3 wt % or from 0.1 wt % to 0.2 wt % based on the total weight of the halogen reservoir.

In some embodiments, the at least one halogen source is present within the activated carbon of the halogen reservoir. In some embodiments, the halogen reservoir comprises a third SPC. In some embodiments, the at least one halogen source fills the SPC of the halogen reservoir.

In some embodiments, the sorbent of the halogen reservoir comprises the same material as at least one of: the first sorbent or the second sorbent. In some embodiments, the sorbent of the halogen reservoir comprises a different material from at least one of: the first sorbent; or the second sorbent.

In some embodiments, the polymer of the halogen reservoir comprises the same material as at least one of: the first polymer (corresponding to the first SPC layer) or the second polymer (corresponding to the second SPC layer). In some embodiments, the polymer of the halogen reservoir comprises a different material from at least one of: the first polymer (corresponding to the first SPC layer) or the second polymer (corresponding to the second SPC layer).

In some embodiments, there is least one permeation control layer positioned between the halogen reservoir and the first SPC layer. In some embodiments, there is at least one permeation control layer positioned between the halogen reservoir and the second SPC layer. In some embodiments, there is at least one permeation control layer positioned between the halogen reservoir and the first SPC layer and at least one permeation control layer positioned between the halogen reservoir and the second SPC layer.

In some embodiments, the at least one permeation control layer has a thickness ranging from 1 μm to 1000 μm.

In some embodiments, the at least one permeation control layer has a thickness of 1 μm, 5 μm, of 10 μm, of 20 μm, of 30 μm, of 40 μm, of 50 μm, of 100 μm, of 200 μm, of 300 μm, of 400 μm, of 500 μm, of 600 μm, of 700 μm, of 800 μm, of 900 μm or of 1000 μm.

The thickness of the at least on permeation control layer may be measured using a cross section scanning electron microscopy.

In some embodiments, the at least one permeation control layer has a thickness ranging from 5 μm to 1000 μm, from 10 μm to 1000 μm, from 20 μm to 1000 μm, from 30 μm to 1000 μm, from 40 μm to 1000 μm, from 50 μm to 1000 μm, from 100 μm to 1000 μm, from 200 μm to 1000 μm, from 300 μm to 1000 μm, from 400 μm to 1000 μm, from 500 μm to 1000 μm, from 600 μm to 1000 μm, from 700 μm to 1000 μm, from 800 μm to 1000 μm or from 900 μm to 1000 μm.

In some embodiments, the at least one permeation control layer has a thickness ranging from 1 μm to 900 μm from 1 μm to 800 μm, from 1 μm to 700 μm, from 1 μm to 600 μm, from 1 μm to 500 μm, from 1 μm to 400 μm, from 1 μm to 300 μm, from 1 μm to 200 μm, from 1 μm to 100 μm, from 1 μm to 50 μm, from 1 μm to 40 μm, from 1 μm to 30 μm, from 1 μm to 20 μm, from 1 μm to 10 μm or from 1 μm to 5 μm.

In some embodiments, the at least one permeation control layer has a thickness ranging from 25 μm to 500 μm. In some embodiments, the at least one permeation control layer has a thickness ranging from 125 μm to 250 μm.

In some embodiments, the at least one permeation control layer comprises at least one permeation control material.

In some embodiments, the at least one permeation control layer is configured to release the at least one halogen source into at least one of the first or second SPC layers at a rate of 0.01% to 0.3% of total halogens/day.

In some embodiments, the at least one permeation control layer is configured to release the at least one halogen source into at least one of the first or second SPC layers at a rate of 0.01% of total halogens/day. In some embodiments, the at least one permeation control layer is configured to release the at least one halogen source into at least one of the first or second SPC layers at a rate of 0.02% of total halogens/day. In some embodiments, the at least one permeation control layer is configured to release the at least one halogen source into at least one of the first or second SPC layers at a rate of 0.05% of total halogens/day. In some embodiments, the at least one permeation control layer is configured to release the at least one halogen source into at least one of the first or second SPC layers at a rate of 0.1% of total halogens/day. In some embodiments, the at least one permeation control layer is configured to release the at least one halogen source into at least one of the first or second SPC layers at a rate of 0.2% of total halogens/day. In some embodiments, the at least one permeation control layer is configured to release the at least one halogen source into at least one of the first or second SPC layers at a rate of 0.3% of total halogens/day.

In some embodiments, the at least one permeation control layer is configured to release the at least one halogen source into at least one of the first or second SPC layers at a rate of 0.01% to 0.2%, of 0.01% to 0.1%, of 0.01% to 0.05% or of 0.01% to 0.02% of total halogens/day.

In some embodiments, the at least one permeation control layer is configured to release the at least one halogen source into at least one of the first or second SPC layers at a rate of 0.02% to 0.3%, of 0.05% to 0.3%, of 0.1% to 0.3% or of 0.2% to 0.3% of total halogens/day.

In some embodiments, the at least one permeation control layer is configured to delay the release of the at least one halogen source into at least one of the first or second SPC layers at a rate of 0.01% to 0.3% of total halogens/day.

In some embodiments, the at least one permeation control layer is configured to delay the release of the at least one halogen source into at least one of the first or second SPC layers at a rate of 0.01%, of 0.02%, of 0.05%, of 0.1%, of 0.2% or of 0.3% of total halogens/day.

In some embodiments, the at least one permeation control layer is configured to delay the release of the at least one halogen source into at least one of the first or second SPC layers at a rate of 0.01% to 0.2%, of 0.01% to 0.1%, of 0.01% to 0.05% or of 0.01% to 0.02% of total halogens/day.

In some embodiments, the at least one permeation control layer is configured to delay the release of the at least one halogen source into at least one of the first or second SPC layers at a rate of 0.02% to 0.3%, of 0.05% to 0.3%, of 0.1% to 0.3% or of 0.2% to 0.3% of total halogens/day.

Some embodiments of the present disclosure relate to methods comprising obtaining an exemplary article disclosed herein and exposing the article to a flue gas stream. In some embodiments, the flue gas stream comprises at least one of sulfur oxides, mercury vapor, or any combination thereof.

In some embodiments, the method further comprises forming the article by disposing the halogen reservoir between the first SPC layer and the second SPC layer, so as to result in a layered structure.

In some embodiments, the method comprises adhering the layered structure together. In some embodiments, adhering may comprise any suitable form of adhesion, such as but not limited to, laminating, gluing, pressing, sewing, stitching, heat bonding, laser bonding, welding, lamination, use of at least one adhesive, or any combination thereof.

In some embodiments, the article further comprises at least one permeation control material in the form of at least one permeation control layer, wherein the step of disposing the halogen reservoir between the first SPC layer and the second SPC layer further comprises disposing the at least one permeation control layer between the first SPC layer and the halogen reservoir, disposing the at least one permeation control layer between the second SPC layer and the halogen reservoir, or any combination thereof.

In some embodiments, the step of disposing the halogen reservoir between the first SPC layer and the second SPC layer comprises disposing a first layer of the at least one permeation control material between the first SPC layer and the halogen reservoir, and disposing a second layer of the at least one permeation control material between the second SPC layer and the halogen reservoir.

In some embodiments, the halogen reservoir comprises at least one permeation control material. In some embodiment, the article is formed by combining at least one halogen source with the at least one permeation control material, so as to form the halogen reservoir, disposing the halogen reservoir between the first SPC layer and the second SPC layer, so as to result in a layered structure, and adhering the layered structure together. In some embodiments, adhering may comprise any suitable form of adhesion, such as but not limited to, heat bonding, laser bonding, welding, lamination, use of at least one adhesive, or any combination thereof. In some embodiments, the least one adhesive may be the at least one permeation control material, as described herein.

In some embodiments, the combining of the at least one halogen source with the at least one permeation control material comprises heating the at least one permeation control material to a temperature sufficient to melt the at least one permeation control material and mixing the at least one melted permeation control material with the at least one halogen source.

In some embodiments, the temperature sufficient to melt the at least one permeation control material corresponds to a melting temperature of at least one permeation control material or combination of permeation control materials described herein.

In some embodiments, the temperature sufficient to melt the at least one permeation control material ranges from 80° C. to 300° C. In some embodiments, the temperature sufficient to melt the at least one permeation control material ranges from 100° C. to 300° C. In some embodiments, the temperature sufficient to melt the at least one permeation control material ranges from 200° C. to 300° C.

In some embodiments, the temperature sufficient to melt the at least one permeation control material ranges from 80° C. to 200° C. In some embodiments, the temperature sufficient to melt the at least one permeation control material ranges from 80° C. to 100° C.

In some embodiment, the temperature sufficient to melt the at least one permeation control material ranges from 90° C. to 220° C. In some embodiments, the temperature sufficient to melt the at least one permeation control material ranges from 130° C. to 180° C.

In some embodiments, the at least one halogen source is mixed with the at least one melted permeation control material. In some embodiments, the at least one halogen source is mixed with the at least one melted permeation control material as a suspension, a solution, an emulsion, a dispersion, or any combination thereof.

In some embodiments, the at least one halogen source is mixed with the at least one melted permeation control material in the gas phase.

In some embodiments, the combining of the at least one halogen source with the at least one permeation control material comprises dissolving the at least one permeation control material in a solvent so as to form a mixture, adding at least one halogen source to the mixture of the solvent and the at least one permeation control material, and evaporating the solvent.

In some embodiments, the solvent may be methylene chloride (DCM), tetrahydrofuran (THF), ethyl acetate (EtOAc), acetone, toluene, or any combination thereof.

In some embodiments, the method further comprises adding particles to the mixture of the at least one halogen source, solvent, and permeation control material. In some embodiments, the particles may be any particles described herein, such as but not limited to, carbon particles.

In some embodiments, the combining of the at least one halogen source with the at least one permeation control material comprises obtaining at least one halogen source, and forming a chemical complex with the at least one halogen source and the at least one permeation control material.

In some embodiments, the chemical complex may comprise a charge transfer complex between elemental iodine and an aromatic ring found, for example, in polystyrene.

In some embodiments, the at least one halogen source forms a chemical complex with the at least one permeation control material with the at least one halogen source in solution. In some embodiments, the at least one halogen source forms a chemical complex with the at least one permeation control material with the at least one halogen source in the gas phase.

In some embodiments, the article comprises a second permeation control material, wherein the second permeation control material is in the form of at least one layer of the second permeation control material, wherein the method further comprises disposing the at least one layer of the second permeation control material between the first SPC layer and the halogen reservoir, disposing the at least one layer of the second permeation control material between the second SPC layer and the halogen reservoir, or any combination thereof.

In some embodiments, the method further comprises disposing a first layer of the second permeation control material between the first SPC layer and the halogen reservoir, and disposing a second layer of the second permeation control material between the second SPC layer and the halogen reservoir.

Some embodiments of the present disclosure relate to systems comprising any of the exemplary articles and/or embodiments of the articles disclosed herein. In some embodiments, the system includes a passageway configured for passage of gas stream therethrough. In some embodiments, the article is housed within the passageway. In some embodiments, at least one of the first layer or the second layer of the article is disposed between the reservoir and the gas stream.

In some embodiments, the system can include several articles formed into a plurality of channels. In such embodiments, the gas stream can flow between the channels such that the gas stream is in direct contact with at least one of: the first or second layer, but not in direct contact with the reservoir. In some embodiments, the plurality of channels of the device can facilitate the flow of reactants, such as gaseous components, over one or more surfaces of the system and facilitate the drainage of at least one liquid product.

Non-limiting exemplary geometries of systems that can include the examples as described herein can be found in U.S. Pat. No. 9,381,459 to Stark et al., which is incorporated herein by reference in entirety for all purposes.

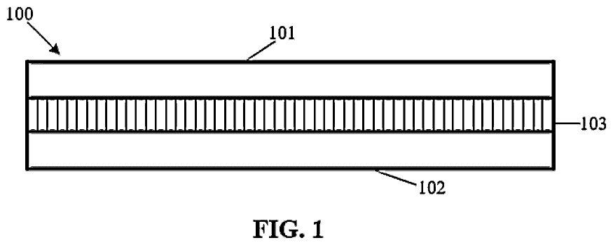

FIG. 1 depicts a non-limiting embodiment of the article described herein. As shown, article 100 can include a first sorbent polymer composite layer 101, a second sorbent polymer composite layer 102 and a halogen reservoir 103 that includes at least one halogen source (not shown).

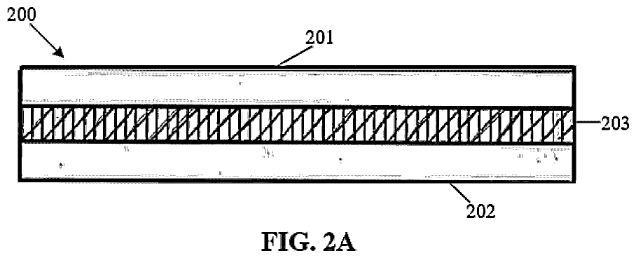

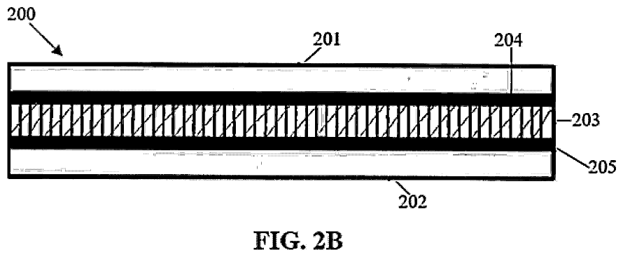

FIG. 2A depicts a further non-limiting embodiment of the article described herein. As shown, article 200 can include a first sorbent polymer composite layer 201, a second sorbent polymer composite layer 202 and a halogen reservoir layer 203, which comprises a third sorbent polymer composite filled with at least one halogen source (not shown). In some non-limiting embodiments, the first sorbent polymer composite layer 201 and the second sorbent polymer composite layer 202 can also be filled with at least one halogen source (not shown).

FIG. 2B depicts a further non-limiting embodiment of article 200. As shown, in some embodiments, article 200 can also include first permeation control layer 204 and second permeation control layer 205. The first permeation control layer 204 is arranged between the first sorbent polymer composite layer 201 and the halogen reservoir layer 203. The second permeation control layer 205 is arranged between the second sorbent polymer composite layer 202 and the halogen reservoir layer 203.

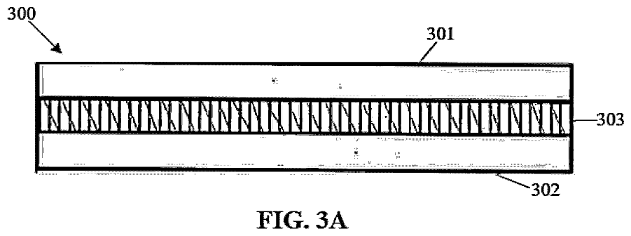

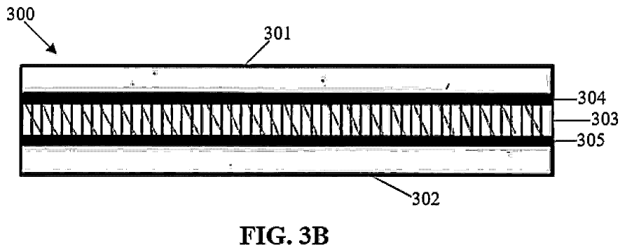

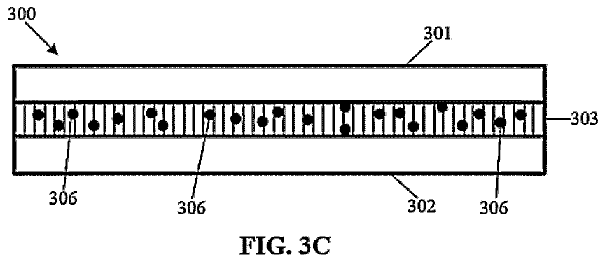

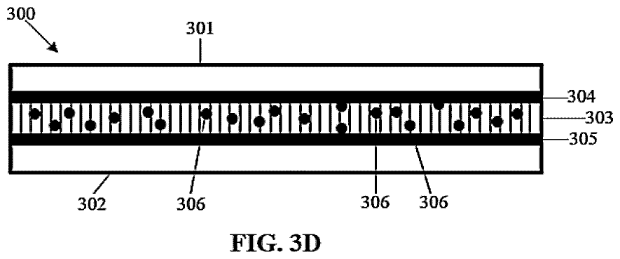

FIG. 3A depicts another non-limiting embodiment of the article described herein. As shown, article 300 can include a first sorbent polymer composite layer 301, a second sorbent polymer composite layer 302 and a halogen reservoir 303 which comprises at least one permeation control material and which is filled with at least one halogen source (not shown).

FIG. 3B depicts a further non-limiting embodiment of article 300. As shown, in some embodiments, article 300 can also include first permeation control layer 304 and second permeation control layer 305.

FIG. 3C depicts another non-limiting embodiment of article 300. As shown, in some embodiments, article 300 can include particles 306 within the halogen reservoir 303.

FIG. 3D depicts a further non-limiting embodiment of article 300. As shown, in some embodiments, article 300 can include first permeation control layer 304, second permeation control layer 305, and particles 306 within the halogen reservoir 303.

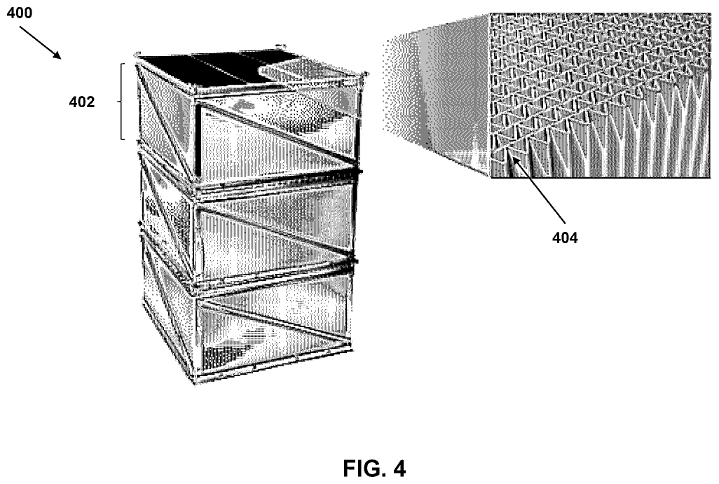

FIG. 4 depicts a non-limiting embodiment of a pollution control system 400 having at least one of the article(s) described herein. Some non-limiting uses of the pollution control system 400 can be for controlling air pollutant emissions to be in compliance with various air pollutant emissions standards. The pollution control system 400 can be configured for capturing elemental and oxidized gas phase mercury from industrial flue gas. The pollution control system 400 can include discrete stackable modules 402 that can be installed downstream of a particulate collection system. In some embodiments, the modules 402 can be configured with one or more embodiments of the article(s) 404 (shown in an enlarged partial view in FIG. 4) described herein.

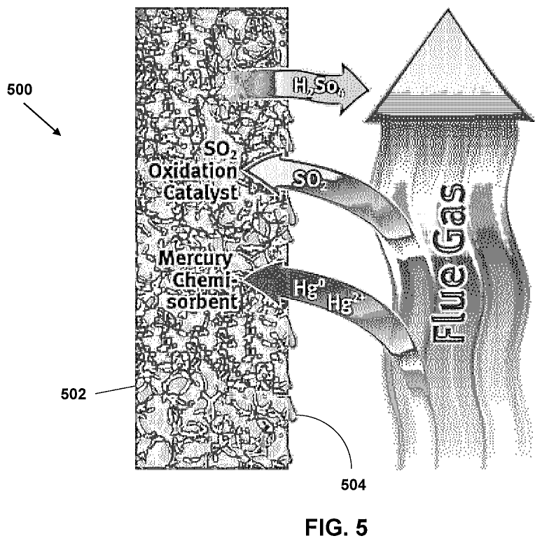

FIG. 5 depicts a non-limiting embodiment showing a schematic diagram 500 of a flue gas flowing over a non-limiting embodiment of the article 502 described herein. The article 502 can capture both elemental and oxidized mercury from the flue gas stream as the flue gas flows past (e.g., over or through the material of the article 502). Mercury can be securely bound within material of the article 502 via chemisorption. SO₂ can also be adsorbed and/or absorbed and catalyzed (via SO₂ oxidation catalyst) to liquid sulfuric acid, which can form droplets 504 and expelled from the article 502.

The droplets 504 can flow downward via gravity on the surface of the article 502.

Various examples of the articles and comparative examples have been tested to show the enhanced properties of the embodiments of the articles implemented into the embodied systems and processes also described herein. The results are described in detail below.

Test Methods

Simulated Flue Gas Stream Durability Test

The Simulated Flue Gas Stream Durability Test is a Laboratory Test. Exemplary tests for simulated exposure to flue gas stream were performed using an apparatus including:
(1) a supply of air regulated by a mass flow controller, a SO₂ source supplied by a gas cylinder containing a 1% sulfur dioxide/nitrogen mixture regulated through a mass flow controller;
(2) a triangular sample cell with 12 mm side length fitted with a bypass, and located in an oven maintained at 65° C.; while
(3) maintaining a high relative humidity of over 80% using an MH-070 permeation tube humidifier (PermaPure, NJ, USA)

Samples were exposed to a simulated flue gas stream in the apparatus as described above containing 300 ppm (786 mg/m³) SO₂ and a humidity of 90% at 1 (one) standard liters/min for a period of about three months, the duration of the test may vary and may be more or less than three months. The total halogen content of the samples was measured over time by X-ray Fluorescence (“XRF”) in wt %. The total halogen content of the samples of the disclosure was determined as total iodine content. Thus, the discussion of halogen content and release rate will be based on iodine content and the release rate of total iodine (total halogen) of the samples.

The relative iodine content was tracked over time according to the formula C_iodine/C_iodine_0 where C_iodine/C_ionine_0 is the total iodine content in the article at a time relative to the initial total iodine content in the article.

The release rate of the total halogen was analyzed by tracking the relative iodine content using an exponential release rate (decay) function according to the formula C_iodine/C_iodine_0=exp(−k*time), where C_iodine is the total iodine content as measured in the respective sample over time, C_iodine_0 the initial total iodine content, and k the iodine release rate constant with units of %/day.

The total release rate is equal to k*C_iodine and the relative release rate is equal to k*C_iodine/C_iodine_0.

The total release rate is equal to the value of the release rate constant (for example, 0.5%/day) multiplied by the total halogens in the article. In other words, the release rate of total halogens from the article is, in this example, 0.5% of the total halogens in the article per day. The relative release rate and the release rate constant have the same units (%/day) but differ in value by the relative iodine content. Sometimes, the iodine content was tracked over time according to the formula C_iodine=C_iodine_0*exp(−k*time), where C_iodine is the iodine content in the article and C_iodine_0 the initial iodine content, and k is the same iodine release rate (decay) constant as above with units of %/day.

The exponential release rate (decay) model was used to estimate the depletion of the halogen source over a long time.

Flue Gas Stream Durability Test

The Flue Gas Stream Durability Test is a field test. Exemplary tests for exposure to an actual flue gas stream were performed by exposing sorbent polymer composite (SPC) laminate samples (representing the article of the present disclosure) to a slipstream of a wet flue gas stream downstream from a desulfurization absorber unit on a coal fired powered plant. The samples were exposed to the flue gas stream in two configurations.

In the first configuration, up to six 3.5″×12″ (8.89 cm×30.48 cm) sheets of sorbent polymer composite (SPC) laminate supported on rods to enable unimpeded flow across the sheets were installed into a 3.5″×3.5″×40″ (8.89 cm×8.89 cm×101 cm) insulated sample fixture. The samples were exposed by pulling approximately 80 ACFM (actual cubic feet per minute), (137 m³/hr) of the flue gas stream through a series of pipes into the sample fixture by a fan.

In the second configuration, 1.25″ by 12″ (3.175 cm×30.48 cm) strips of sorbent polymer composite (SPC) laminate were installed on a frame fixture 2′×2′×1′ (61 cm×61 cm×30 cm) whereas the top and bottom of the strip was fixed in place along rails of the frame capable of holding up to 100 strips. The rails were separated by 2 inches (50 mm) to provide unimpeded flow across the frame. The frame was inserted into a 2.1′×2.1′×8′ (0.66 m×0.66 m×2.4 m) insulated Pilot Tower Unit. The samples were exposed by pulling approximately 2880 ACFM (4860 m³/hr) of the flue gas stream using a fan.

Samples according to this disclosure were tested in either the first configuration or the second configuration or both.

In both configurations, the flow rate and pressure differential were monitored across the sample fixture. By nature, the composition of the flue gas stream was highly variable, however the typical composition of the flue gas stream comprised a mercury concentration of 2 μg/m³, an SO₂ concentration of 20-40 ppm, an 02 concentration of 6%, a NO concentration of 200 ppm, and the relative humidity was >95%. The slipstream flue gas temperature was 50-55° C.

Approximately once per month (every 30 days), a sample was taken and analyzed by X-ray Fluorescence (“XRF”) for total halogen content in wt %. The total halogen content of the samples of the disclosure was determined as total iodine content. Thus, the discussion of halogen content and release rate will be based on iodine content and the release rate of total iodine (total halogen) of the samples.

The total iodine content of each sample was converted to the iodine content relative to the initial iodine content (“relative iodine content”) and was tracked over time as described in the Tables below.

The release rate of total halogens corresponds to the release rate of iodine as analyzed by the examples of the inventions.

The release rate of total iodine was analyzed by tracking the relative iodine content using an exponential release rate (decay) function according to the formula

C_iodine/C_iodine_0=exp(−k*time), where C_iodine is the total iodine content in the respective sample, C_iodine_0 the initial total iodine content, and k the iodine release rate (decay) constant with units of %/day. The total release rate is equal to k*C_iodine and the relative release rate is equal to k C_iodine/C_iodine_0.

The total release rate is equal to the value of the release rate constant (for example, 0.5%/day) multiplied by the total halogens in the article. In other words, the release rate of total halogens from the article is, in this example, 0.5% of the total halogens in the article per day. The relative release rate and the release rate constant have the same units (%/day) but differ in value by the relative iodine content. The exponential release rate (decay) model was used to estimate the depletion of the halogen source over a long time.

EDX Testing

Energy-dispersive X-ray spectroscopy (EDX) is an analytical technique in which an electron beam hits a sample and produces an energetic shift in the electrons of the sample. This shift causes the sample to emit an X-ray signature which allows for identification of the elemental composition of the sample. The signal is observed in an image of the sample with the light intensity reflecting the relative concentration of the target component.

### EXAMPLES

The following Examples are meant to illustrate certain non-limiting embodiments of the present disclosure.

### Example 1

Sorbent Polymer Composite (SPC)

SPC Material 1A. AN SPC was created under laboratory conditions comprising 80% activated carbon (Norit PAC20BF, Cabot Inc., TX, USA) and 20% PTFE and was prepared using the general dry blending methodology taught in U.S. Pat. No. 7,791,861 to form composite samples that were then uniaxially expanded according to the teachings of U.S. Pat. No. 3,953,566. SPC Material 1A had a thickness of ˜25 mils (0.635 mm).

SPC Material 1B. AN SPC created under laboratory conditions comprising 50% activated carbon (Norit PAC20BF, Cabot Inc., TX, USA), 30% PTFE, 5% sulfur, and 15% tetrabutylammonium iodide (TBAI) was prepared using the general dry blending methodology taught in U.S. Pat. No. 7,791,861 to form composite samples that were then uniaxially expanded according to the teachings of U.S. Pat. No. 3,953,566. The SPC Material 1B had a thickness of ˜25 mils (0.635 mm).

Halogen Reservoir Comprising SPC Material

Halogen Reservoir 1A. A halogen reservoir created under laboratory conditions comprising 40% activated carbon (NUCHAR SA-20, Ingevity, SC, USA), 30% PTFE, 20% of potassium iodide (KI) as halogen source, and 10% of ferric oxide (Fe2O3) was prepared using the general dry blending methodology taught in U.S. Pat. No. 7,791,861 to form a halogen reservoir. Halogen Reservoir 1A had a thickness of 25-30 mils (0.635-0.762 mm).

Halogen Reservoir 1B. A halogen reservoir created under laboratory conditions comprising 40% activated carbon (Norit PAC20BF, Cabot Inc., TX, USA), 30% PTFE, 20% of potassium iodide (KI) as halogen source, and 10% of ferric oxide (Fe2O3) was prepared using the general dry blending methodology taught in U.S. Pat. No. 7,791,861 to form a halogen reservoir. Halogen Reservoir 1B had a thickness of 25-30 mils (0.635-0.762 mm).

Halogen Reservoir 1C. A halogen reservoir created under laboratory conditions comprising 35% activated carbon (NUCHAR SA-20, Ingevity, SC, USA), 20% PTFE, 20% of tetrabutylammonium iodide (TBAI) as halogen source, and 25% of PVDF (Hylar 301F, Solvay Specialty Polymers, LLC, DE, USA) was prepared using the general dry blending methodology taught in U.S. Pat. No. 7,791,861 to form a halogen reservoir. Halogen Reservoir 1C had a thickness of 25-30 mils (0.635-0.762 mm).

Halogen Reservoir 1D. A halogen reservoir created under laboratory conditions comprising 35% activated carbon (Norit PAC20BF, Cabot Inc., TX, USA), 20% PTFE, 20% of tetrabutylammonium iodide (TBAI) as halogen source, and 25% of PVDF (Hylar 301F, Solvay Specialty Polymers, LLC, DE, USA) was prepared using the general dry blending methodology taught in U.S. Pat. No. 7,791,861 to form a halogen reservoir. Halogen Reservoir 1D had a thickness of 25-30 mil (0.635-0.762 mm).

Permeation Control Material in the Form of an Adhesive Layer

Adhesive Layer 1A. A permeation control material, which took the form of an adhesive layer comprising a discontinuous PVDF NALTEX extruded netting was used (Delstar Technologies, Inc., DE, USA). Adhesive Layer 1A had a thickness of 25 mil (0.635 mm).

Adhesive Layer 1B. A permeation control material, which took the form of an adhesive layer comprising a continuous PVDF film was used (SOLEF PVDF 9009, Solvay Specialty Polymers, LLC, DE, USA)). Adhesive Layer 1B had a thickness of 2 mil (0.05 mm).

Exemplary Articles

Article 1A: A five-layer SPC laminate was constructed in the following order: a) a first SPC layer comprising SPC Material 1A; b) a first adhesive layer comprising Adhesive 1A; c) a halogen reservoir layer comprising Halogen Reservoir 1A; d) a second adhesive layer comprising Adhesive 1A; e) a second SPC layer comprising SPC Material 1A. The layers were cut into 30.5 cm×20.3 cm (12″×8″) strips and laminated in a belt laminator at 175° C., and about 413-620 kPa (˜60-90 psi) producing a five-layer SPC laminate, Article 1A.

Article 1B: A five-layer SPC laminate was constructed in the following order: a) a first SPC layer comprising SPC Material 1A; b) a first adhesive layer comprising Adhesive 1A; c) a halogen reservoir layer comprising Halogen Reservoir 1B; d) a second adhesive layer comprising Adhesive 1A; e) a second SPC layer comprising SPC Material 1A. The layers were cut into 30.5 cm×20.3 cm (12″×8″) strips and laminated in a belt laminator at 175° C., and about 413-620 kPa (˜60-90 psi) producing a five-layer SPC laminate, Article 1B.

Article 1C: A three-layer SPC laminate was constructed in the following order: a) a first SPC layer comprising SPC Material 1A; b) a halogen reservoir layer comprising Halogen Reservoir 1C; c) a second SPC layer comprising SPC Material 1A. The addition of PVDF to the reservoir formulation obviated the need for an adhesive layer. The layers were cut into 30.5 cm×20.3 cm (12″×8″) strips and laminated in a belt laminator at 175° C., and about 413-620 kPa (˜60-90 psi) producing a three-layer SPC laminate, Article 1C.

Article 1D: A three-layer SPC laminate was constructed in the following order: a) a first SPC layer comprising SPC Material 1A; b) a halogen reservoir layer comprising Halogen Reservoir 1 D; c) a second SPC layer comprising SPC Material 1A. The addition of PVDF to the reservoir formulation obviated the need for an adhesive layer. The layers were cut into 30.5 cm×20.3 cm (12″×8″) strips and laminated in a belt laminator at 175° C., and ˜about 413-620 kPa (60-90 psi) producing a three-layer SPC laminate, Article 1 D.

Flue Gas Stream Durability Test. Article 1C and Article 1D were mounted in the flue gas durability test as described above and total iodine content was measured over time. The total iodine content was converted to the iodine content relative to the initial iodine content as shown in Table 1.

The release rate constant (iodine content decay constant k), for Article 1C was 1.3%/day, and for Article 1D was 0.22%/day.

TABLE 1
Flue Gas Stream Durability Test

| | Relative iodine content | Relative iodine content |
|---|---|---|
| Time (days) | of Article 1C | of Article 1D |
| 0 | 1.00 | 1.00 |
| 7 | 0.96 | 1.00 |
| 14 | 0.96 | 1.00 |
| 33 | 0.67 | 0.94 |
| 62 | 0.25 | 0.85 |
| 125 | 0.26 | 0.74 |
| 138 | 0.17 | 0.75 |

When the flue gas stream durability data was extrapolated using the exponential release rate model (as shown in FIG. 6A by respective dashed lines), Article 1C displayed 90% depletion (illustrated by horizontal line L) of less than 200 days. In some embodiments, the selection of activated carbon may be used to adjust the rate of release of iodine from the reservoir. For example, Article 1 D, which utilized a different type of activated carbon then Article 1C, provided a significant boost in durability, displaying 90% depletion of about 1000 days. FIG. 6A shows the relative iodine content over time for Article 1C (three layer SPC laminate) and Article 1D (three layer SPC laminate).

Article 1A and Article 1B were mounted in the flue gas durability test and relative iodine content was tracked over time as shown in Table 2. The release rate constant (iodine content decay constant k), for Article 1A was 0.63%/day and for Article 1B was 0.30%/day.

TABLE 2
Flue Gas Stream Durability Test

| | Relative iodine content of | Relative iodine content of |
|---|---|---|
| Time (days) | Article 1A | Article 1B |
| 0 | 1.000 | 1.000 |
| 11 | — | 0.892 |
| 33 | 0.616 | 0.941 |
| 72 | 0.361 | 0.762 |
| 180 | 0.311 | 0.592 |
| 273 | 0.216 | 0.450 |

FIG. 6B shows the relative iodine content versus time of Article 1A and Article 1B (both five layer SPC laminate). For Article 1A, 90% depletion was estimated at approximately 400 days. Article 1B, which utilized a different type of activated carbon then Article 1A, provided a significant boost in durability, displaying 90% depletion estimated at approximately 800 days (illustrated by horizontal line L). In some embodiments, the selection of activated carbon may be used to adjust the rate of release of iodine from the reservoir.

### Example 2

Halogen reservoir samples with and without permeation control layers (Comparative Example)

Halogen Reservoir 2A without permeation control layers. Iodine loaded polymer was prepared by exposing a 2.5 cm×8.1 cm and 0.79 mm thick polystyrene (PS) sheet (part No. 8734K31, McMasterCarr Supply Co., IL, USA) with excess iodine (I) in a sealed container at 90° C. for a period of 48 hours, which resulted in an iodine loading of approximately 40% by weight.

Halogen Reservoir 2B with permeation control layers. Halogen Reservoir 2A was coated using a 2-part epoxy (part No. 66195A13, McMasterCarr Supply Co., IL, USA) to cover all surfaces of the reservoir to form a three-layer reservoir.

Halogen Reservoir 2C without permeation control layers. Iodine loaded polymer was prepared by exposing a 1.0 cm×6.0 cm and 0.79 mm thick polystyrene (PS) sheet (part No. 8734K31, McMasterCarr Supply Co., IL, USA) with excess iodine (I) in a sealed container at 80° C. for a period of 16 hours, which resulted in an iodine loading of approximately 20% by weight.

Halogen Reservoir 2D with permeation control layers. Halogen reservoir 2C was laminated on a belt laminator using 248-276 kPa (36-40 psi) gauge pressure and 175° C. between two or more 1 mil (0.025 mm)thick PVDF films (permeation control layers) (SOLEF PVDF 9009, Solvay Specialty Polymers, LLC, DE, USA) to form a three or more layered halogen reservoir.

The halogen reservoir 2D was manufactured in different embodiments:
a) Halogen Reservoir 2D (4): 4 permeation control layers were laminated on each surface of the halogen reservoir 2C
b) Halogen Reservoir 2D (5): 5 permeation control layers were laminated on each surface of the halogen reservoir 2C
c) Halogen Reservoir 2D (6): 6 permeation control layers were laminated on each surface of the halogen reservoir 2C
d) Halogen Reservoir 2D (8): 8 permeation control layers were laminated on each surface of the halogen reservoir layer 2C

Iodine Stability Test

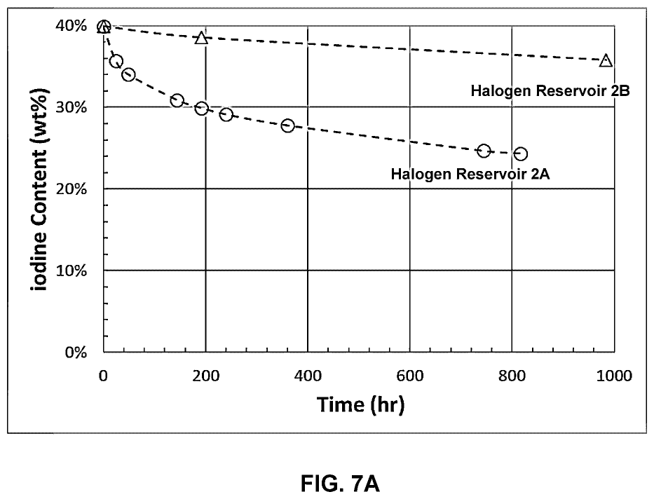

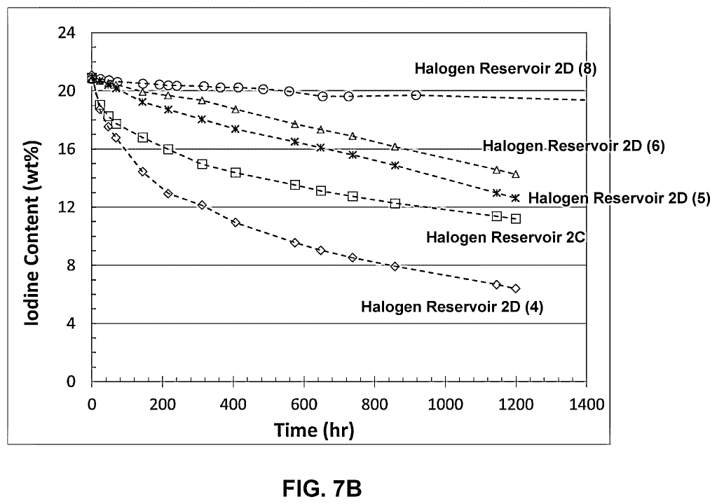

The stability of Halogen Reservoir 2A and 2B was tested by exposing the samples to heat inside an oven at 60° C. for about 1000 hours. Halogen Reservoir 2A and 2B were each placed in a vial and then closed with a cap. The vial also included activated carbon to capture the lost iodine. The total iodine content in wt % of Halogen Reservoir 2A and 2B was determined over time during the test by weight measurement and normalized to just the halogen reservoir not including the permeation control layers (sample 2A). Halogen Reservoir 2B exhibited a significantly slower release of iodine, due to the barrier created by the permeation control layers of cross-linked epoxy. Comparative iodine release rates are summarized in FIG. 7A.

The stability the Halogen Reservoir 2C and 2D was tested by exposing the samples to heat inside an oven at 60° C. for about 1200 hours and more. Halogen Reservoir 2C and 2D were placed in a vial and then closed with a cap. The vial also included activated carbon to capture the lost iodine. The iodine content in wt % of Halogen Reservoir 2C and 2D were determined over time during the test by weight measurement and normalized to just the halogen reservoir not including the permeation control layers (sample 2C). Halogen Reservoir 2D exhibited a significantly slower release of iodine compared to Halogen Reservoir 2C, due to the barrier created by the permeation control layers of PVDF layers. Comparative iodine release rates are influenced by the number of PVDF permeation control material layers and are summarized in FIG. 7B. As shown in FIG. 7B, the halogen release rate may vary as a function of the number of permeation control layers. In particular, Halogen Reservoir 2C and 2D were tested with 0 to 8 layers of permeation control material in the form of a PVDF film on each side of the halogen reservoir to illustrate the release rate properties of the at least one permeation control material. Even if it appears that 2C is intrinsically better than 2D, but adding more permeation control layers can improve the performance of 2D beyond that of 2C.

### Example 3

SPC Laminate Comprising Halogen Reservoir Layer Comprising Iodine Loaded Carbon

Iodine Loaded Carbon 3A. Iodine on carbon was prepared by mixing 100 grams of iodine (I) with 300 grams of activated carbon (Norit PAC20BF, Cabot Inc., TX, USA). The mixture was heated to 60° C. in a sealed glass vessel for 4-6 hours, which resulted in an iodine loading of the activated carbon of approximately 25% by weight.

Halogen Reservoir Solution

Halogen Reservoir Solution 3A. Two grams of Iodine Loaded Carbon 3A was added to a solution of 25 ml of 4 wt % PVDF (Kynar Superflex 2501-20, Arkema Inc., PA, USA) in tetrahydrofuran (THF) solvent and 10 ml of additional THF solvent to reduce the viscosity, resulting in an 12-carbon PVDF ratio of 2:1.

Halogen Reservoir Solution 3B. 2.4 grams of Iodine Loaded Carbon 3A was added to a solution of 23 mL of 16 wt % PVDF (Kynar Superflex 2501-20, Arkema Inc., PA, USA) in tetrahydrofuran (THF) solvent and 10 mL of additional THF solvent to reduce the viscosity, resulting in an 12-carbon PVDF ratio of 1:1.5.

Halogen Reservoir Solution 3C. A 16 wt % solution of PVDF (Kynar Superflex 2501-20, Arkema Inc., PA, USA) in tetrahydrofuran (THF) solvent was mixed with sufficient Iodine Loaded Carbon 3A to provide an 12-carbon PVDF ratio of 1:1.5.

Halogen Reservoir Solution 3D. A 21 wt % solution of PVDF (Kynar Superflex 2501-20, Arkema Inc., PA, USA) in tetrahydrofuran (THF) solvent was mixed with sufficient Iodine Loaded Carbon 3A to provide an 12-carbon PVDF ratio of 1:1.5.

Halogen Reservoir Solution 3E. A 16 wt % solution of PVDF (Kynar Superflex 2501-20, Arkema Inc., PA, USA) in tetrahydrofuran (THF) solvent was mixed with sufficient Iodine Loaded Carbon 3A to provide an 12-carbon:PVDF ratio of 1:1.25.

Halogen Reservoir Solution 3F. A 20 wt % solution of PVDF (Kynar Superflex 2501-20, Arkema Inc., PA, USA) in tetrahydrofuran (THF) solvent was mixed with sufficient Iodine Loaded Carbon 3A to provide an 12-carbon:PVDF ratio of 1:1.

Permeation Control Material Solution

Permeation Control Material Solution 3A. A solution was prepared of 18 wt % PVDF (Kynar Superflex 2501-20, Arkema Inc., PA, USA) in tetrahydrofuran (THF) solvent.

Permeation Control Material Solution 3B. A solution was prepared of 20 wt % PVDF (Kynar Superflex 2501-20, Arkema Inc., PA, USA) in tetrahydrofuran (THF) solvent.

Sorbent Polymer Composite (SPC) (without Halogen Source)

Sorbent polymer composite (SPC) Material 3A. A sorbent polymer composite (SPC) was created under laboratory conditions comprised of 80 parts activated carbon (Norit PAC20BF, Cabot Inc., TX, USA) and 20 parts PTFE and was prepared using the general dry blending methodology taught in U.S. Pat. No. 7,791,861 to form SPC Material 3A.

Sorbent polymer composite (SPC) Material 3B. A sorbent polymer composite (SPC) was created under laboratory conditions comprising 75 parts activated carbon (Norit PAC20BF, Cabot Inc., TX, USA) and 25 parts PTFE, and was prepared using the general dry blending methodology taught in U.S. Pat. No. 7,791,861 to form composite samples that were then uniaxially expanded according to the teachings of U.S. Pat. No. 3,953,566 to form SPC Material 3B.

Exemplary Articles

Article 3A: Halogen Reservoir Solution 3A was applied onto the surface of several 1.25″×12″ (3.175 cm×30.48 cm) strips of SPC Material 3A using an airbrush (Master E91 airbrush, TCP Global Corp., CA, USA) at approximately 138 kPa (20 psi) gauge pressure. The SPC material strip thickness was 0.617 mm before coating and 0.907 mm after coating and drying (average based on 8 SPC strips), indicating a thickness gain of 0.290 mm. The average weight of the added coating was 1.37 grams. The coated sides of a pair of the coated and dried SPC material strips were mated and laminated on a belt laminator using 248-276 kPa (36-40 psi) gauge pressure and 180° C. forming SPC laminates. Four laminates were prepared for durability testing. The initial total iodine content of these prototypes was determined to be 3.29 wt % by x-ray fluorescence (XRF) analysis.

Article 3B: Halogen Reservoir Solution 3B was applied onto the surface of several 1.25″×12″ (3.175 cm×30.48 cm) strips of SPC Material 3A using an airbrush (Master E91 airbrush, TCP Global Corp., CA, USA) at approximately 138 kPa (20 psi) gauge pressure. The SPC strip thickness was 0.617 mm before coating and 0.944 mm after coating and drying (average based on 8 SPC strips), indicating a thickness gain 0.327 mm. The average weight of the added coating was 1.38 grams. The coated sides of a pair of the coated and dried SPC strips were mated and laminated on a belt laminator using 248-276 kPa (36-40 psi) gauge pressure and 180° C. forming SPC laminates. Four laminates were prepared for durability testing. The initial total iodine content of these prototypes was determined to be 4.14 wt % by x-ray fluorescence (XRF) analysis.

Flue Gas Stream Durability Tests. Articles 3A and 3B were suspended in the flue gas stream durability test and relative iodine concentration was tracked over time as described in Table 3. The halogen release rate constant (iodine content decay constant, k,) for Article 3A was 0.65%/day and for Article 3B was 0.13%/day.

TABLE 3
Flue Gas Stream Durability Test

| | Article 3A | Article 3B |
|---|---|---|
| Time (days) | Relative iodine content | Relative iodine content |
| 0 | 1 | 1 |
| 24 | 0.59 | 0.82 |
| 101 | 0.44 | 0.74 |
| 162 | 0.31 | 0.78 |

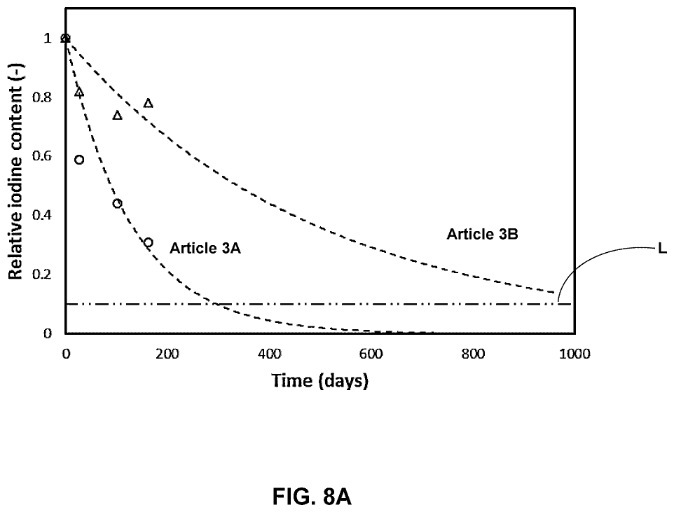

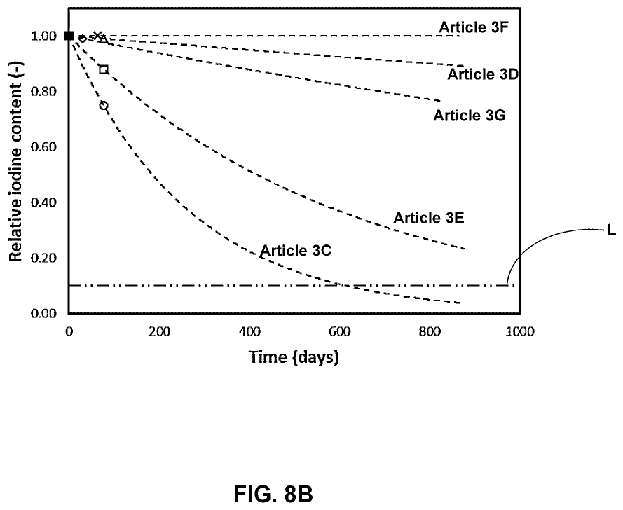

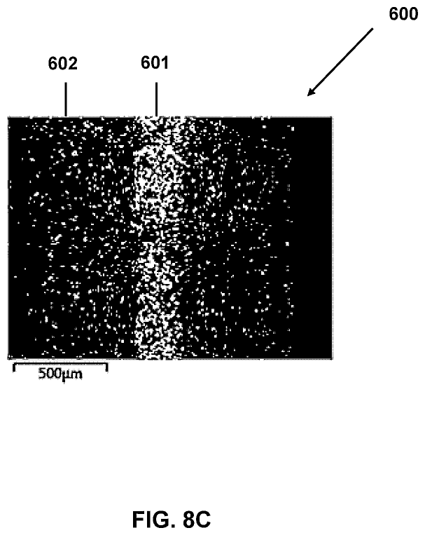

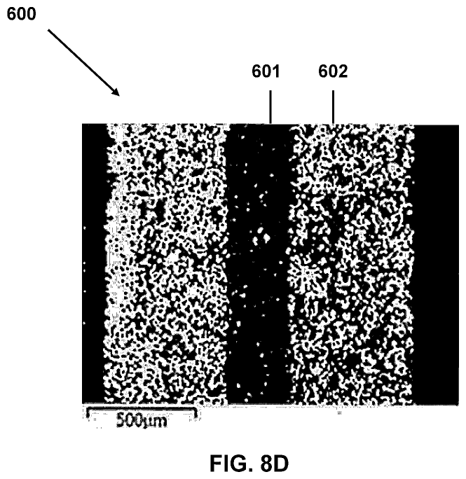

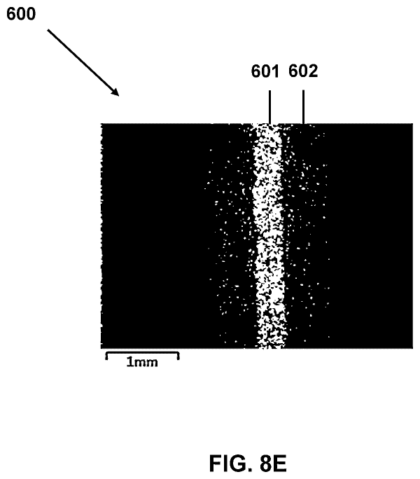

FIG. 8A shows the relative iodine contents of Article 3A and 3B versus time as described in table 3. When the flue gas stream durability data was extrapolated using the exponential release rate (decay) model as also shown in FIG. 8A by respective dashed lines, Article 3A displayed iodine release of less than 1 year before approaching 90% depletion (illustrated by horizontal line L). Article 3B displayed iodine release of greater than 3 years before approaching 90% depletion.

Article 3C: Halogen Reservoir Solution 3C was applied to the surface of a 4 inch (10.16 cm) wide roll of SPC Material 3B using roll to roll coating. The solution was charged to a mixing tank and then applied to the SPC material using a coating head with a gap of 15 mil (0.381 mm). The coated wet SPC layer was passed through an oven at 104° C. for about 15 min, where it was dried, then collected on a take-up roll. Two layers of the dried SPC were mated and laminated on a belt laminator using 248-276 kPa (36-40 psi) gauge pressure and 150° C. A portion of the sample was analyzed by X-ray Fluorescence (“XRF”) and shown to contain an initial total iodine content of approximately 0.218 wt %.

Article 3D: Halogen Reservoir Solution 3D was applied to the surface of a 4 inch (10.16 cm) wide roll of SPC Material 3B using roll to roll coating. The solution was charged to a mixing tank and then applied to the SPC material using a coating head with a gap of 20 mil (0.508 mm). The coated wet SPC layer was passed through an oven at 104° C. for about 20 min, where it was dried, then collected on a take-up roll. Two layers of the dried SPC were mated and laminated on a belt laminator using 248-276 kPa (36-40 psi) gauge pressure and 150° C. A portion of the sample was analyzed by X-ray Fluorescence (“XRF”) and shown to contain an initial total iodine content of approximately 0.245 wt %.

Article 3E: Halogen Reservoir Solution 3C was applied to the surface of a 4 inch (10.16 cm) wide roll of SPC Material 3B using roll to roll coating. The solution was charged to a mixing tank and then applied to the SPC material using a coating head with a gap of 50 mil (1.27 mm). The coated wet SPC layer was passed through an oven at 104° C. for about 30 min, where it was dried, then collected on a take-up roll. Two layers of the dried SPC were mated and laminated on a belt laminator using 248-276 kPa (36-40 psi) gauge pressure and 150° C. A portion of the sample was analyzed by X-ray Fluorescence (“XRF”) and shown to contain an initial total iodine content of approximately 0.310 wt %.

Article 3F: Permeation Control Material Solution 3A was applied as first coating to the surface of a 4 inch (10.16 cm) wide roll of SPC Material 3B using roll to roll coating. The solution was charged to a mixing tank and then applied to the SPC material using a coating head with a gap of 10 mil (0.254 cm). The coated wet SPC layer was passed through an oven at 104° C. for about 7 min, where it was dried, then collected on a take-up roll. A second coating of the Halogen Reservoir Solution 3E was applied to the surface of the dried permeation control material layer using roll to roll coating. The solution was charged to a mixing tank and then applied to the dried permeation control material layer of the SPC material 3B using a coating head with a gap of 40 mil (1.016 mm). The coated wet SPC layer was passed through an oven at 104° C. for about 7 min, where it was dried, then collected on a take-up roll. Two layers of the dried SPC were mated and laminated on a belt laminator using 248-276 kPa (36-40 psi) gauge pressure and 150° C. A portion of the sample was analyzed by X-ray Fluorescence (“XRF”) and shown to contain an initial iodine content of approximately 1.15 wt %.

Article 3G: Permeation Control Material Solution 3B was applied as first coating to the surface of a 4 inch (10.16 cm) wide of SPC Material 3B using casting knife film applicator. The solution was applied to the SPC material using a coating head with a gap of 10 mil (0.254 cm). A second coating of the Halogen Reservoir Solution 3F was applied to the surface of the dried permeation control material layer of SPC Material 3B using casting knife film applicator. The solution was applied to the SPC material using a coating head with a gap of 40 mil (1.016 mm). The coated wet SPC layer was dried at room temperature overnight. Two layers of the dried SPC were mated and laminated on a belt laminator using 248-276 kPa (36-40 psi) gauge pressure and 150° C. A portion of the sample was analyzed by X-ray Fluorescence (“XRF”) and shown to contain an initial iodine content of approximately 4.85 wt %.

Flue Gas Stream Durability Test

Articles 3C-3G were tested in the flue gas stream durability test and the relative iodine content was tracked over time as described in Table 4. The halogen release rate constant (iodine content decay constant, k,) was 0.39%/day for Article 3C, 0.01%/day for Article 3D, 0.17%/day for Article 3E, 0.00%/day for Article 3F, and 0.03%/day for Article 3G. FIG. 8B shows the relative iodine content of Articles 3C-3G versus time. When the flue gas stream durability data was extrapolated using the exponential release rate (decay) model as shown also in FIG. 8B by respective dashed lines, Article 3C displayed iodine release of about 2 years before approaching 90% depletion (illustrated by the horizontal line L). Article 3D, 3E, 3F and 3G have a much longer iodine release of many years.

TABLE 4
Flue Gas Stream Durability Test

| | Article 3C | Article 3D | Article 3E | | Article 3F | | Article 3G |
|---|---|---|---|---|---|---|---|
| | Relative | Relative | Relative | | Relative | | Relative |
| Time | iodine | iodine | iodine | Time | iodine | Time | iodine |
| (days) | content | content | content | (days) | content | (days) | content |
| 0 | 1.00 | 1.00 | 1.00 | 0 | 1.00 | 0 | 1.00 |
| 77 | 0.75 | 0.99 | 0.88 | 64 | 1.00 | 31 | 0.99 |

EDX Test

A cross section 600 of Article 3B following 101 days of field exposure was analyzed according to the EDX test (energy dispersive X-Ray analysis). The EDX test is mapping the iodine (halogen) content of the cross section of Article 3B, showing that the halogen reservoir layer 601 was still intact, as indicated by the high light intensity in the center of the cross section, and that iodine was released into the SPC layers 602 as indicated by the diffuse dots in the SPC layers 602, as shown in FIG. 8C. The same cross section of Article 3B following 101 days of field exposure was analyzed according to the EDX test (energy dispersive X-Ray analysis) for indicating sulfur content. FIG. 8D showed that the SPC layers 602 were also highly effective as a barrier to SO₂ and sulfuric acid, as indicated by the bright intensity in the SPC layers 602 and low light intensity in the halogen reservoir layer 601.

A cross section 600 of Article 3G following 31 days of field exposure was analyzed according to the EDX test analyzing for iodine (halogen) content. FIG. 8E is indicating that the halogen reservoir layer 601 was intact as indicated by the light intensity in the center of the cross section, and that iodine (halogen) was released into the SPC layers 602 as indicated by the diffuse dots in the SPC layers 602 of the sample.

### Example 4 (SPC Layers without Halogen Source)

Sorbent Polymer Composite (SPC)

SPC Material 4A. AN SPC was created under laboratory conditions comprising 75% activated carbon (Norit PAC20BF, Cabot Inc., TX, USA) and 25% PTFE was prepared using the general dry blending methodology taught in U.S. Pat. No. 7,791,861 to form composite samples that were then uniaxially expanded according to the teachings of U.S. Pat. No. 3,953,566.

SPC Material 4B. AN SPC was created under laboratory conditions comprising 72% activated carbon (Norit PAC20BF, Cabot Inc., TX, USA), 22% PTFE, and 6% sulfur was prepared using the general dry blending methodology taught in U.S. Pat. No. 7,791,861 to form composite samples.

Halogen Reservoir Layer Components

The halogen reservoir layer of the following examples is composed of an iodide salt (halogen source) mixed with polyolefin (permeation control material) and comprises the following components: Iodide Salt 4A: Tetrabutylammonium Iodide (TBAI); Iodide Salt 4B: ethyltriphenylphosphonium Iodide (ETTPI); Hot Melt Adhesive 4A (RT6825 by REXTac LLC, TX, USA); Hot Melt Adhesive 4B (RT2535 by REXTac LLC, TX, USA).

Article 4A (3 layer SPC laminate). SPC Material 4A layers were cut into 14 cm×30 cm pieces. The SPC Material 4A pieces were passed through a roll-coater (model: HOT COAT™ 16 made by Glue Machinery Corporation, MD, USA). The coater was loaded with a permeation control material in the form of Hot Melt Adhesive 4A. Hot Melt Adhesive 4A was applied to a layer of SPC Material 4A using a coating head with a 15 mil (0.381 mm) gap. The bath setting was 350° F. (176.6° C.) and the roll temperature setting was 220° F. (104.4° C.). The SPC layer 4A was then laid flat with the side of the Hot Melt Adhesive 4A facing up. Approximately 1.5 g of iodide Salt 4A (TBAI) was then sprinkled on the hot melt adhesive, thereby forming an SPC layer with a wet coated halogen reservoir layer. Two pieces of the SPC layer 4A with wet coated reservoir layers were mated before the permeation control material in the form of the hot melt adhesive solidified by facing the halogen reservoir layers so that it sandwiches the iodine salt 4A (TBAI) between two layers of the polyolefin permeation control material. The Article 4A of a three-layer SPC laminate with a halogen reservoir of polyolefin permeation control material and TBAI as halogen source as middle layer was formed.

Comparative Article 4AA. SPC Material 4A layers were cut into 14 cm×30 cm pieces. The SPC Material 4A piece was passed through a roll-coater (model: HOT COAT™ 16 made by Glue Machinery Corporation, MD, USA). The coater was loaded with Hot Melt Adhesive 4A. Hot Melt Adhesive 4A was applied to the layer of SPC Material 4A using a coating head with a 15 mil (0.381 mm) gap. The bath setting was 350° F. (176.6° C.) and the roll temperature setting was 220° F. (104.4° C.), forming an SPC layer with a wet coated reservoir layer. Two pieces of the SPC layer 4A with wet coated halogen reservoir layers were mated by facing the polyolefin permeation control layers, thereby forming Article 4AA as three-layer SPC laminate.

Comparative Article 4BB. A permeation control material in the form of Hot Melt Adhesive 4B (2535, REXTac LLC, TX, USA) was melted in an aluminum pan on top of a first hot plate. The temperature setting of the hot plate knob was 200° C. SPC Material 4B layers were cut into 14 cm×30 cm pieces. A first SPC Material 4B piece was placed on a second hot plate (temperature of hot plate measured by IR thermometer˜108° C.). The first SPC piece had a thickness of 0.63 mm. The edges of the first SPC piece were covered with aluminum foil by about 2 cm on each side, leaving about 10 cm×30 cm exposed. Part of Hot Melt Adhesive 4B was poured on top of the first SPC piece and was spread using a metal spatula. Before the hot melt adhesive solidified, a second piece of SPC Material 4B with a thickness of 0.62 mm was placed on top and it was gently pressed by hand and spatula until a bond was formed. Article 4BB had an overall thickness of 1.508 mm. The average thickness of the permeation control layer was 0.256 mm, estimated by subtracting the thickness of SPC Material 4B from that of Article 4BB.

Article 4B. Article 4B was prepared according to the procedure as described for the Article 4BB. The permeation control material in the form of Hot Melt Adhesive 4B was melted on top of a first hot plate (temperature setting˜220° C.). A first SPC Material 4B piece with the size of 14×30 cm and a thickness of 0.62-0.63 mm was placed on a second hot plate with a temperature of ˜120° C. Samples were prepared using the procedure described for Article 4BB, however before pouring Hot Melt Adhesive 4B on the first SPC Material 4B piece, a predetermined amount of Iodide Salt 4B (ETPPI) was mixed with Hot Melt Adhesive 4B using a glass stirring rod. The average content of ETPPI in Hot Melt Adhesive 4B was about 30% by weight. Before the hot melt adhesive solidified, a second piece of SPC Material 4B was placed on top and it was gently pressed by hand and spatula until a bond was formed. Article 4B had an average thickness of ˜1.8 mm. The average thickness of the Hot Melt Adhesive Layer was ˜0.47 mm, estimated by subtracting the thickness of the two SPC Material 4B from that of article 4B. Thereby a three layer SPC laminate (Article B) was formed with two SPC layers (SCP material 4B) and a halogen reservoir made of permeation control material (Hot Melt Adhesive 4B) mixed with a halogen source (Iodide Salt) 4B between the two SPC layers.

Samples of SPC laminates having halogen reservoir layers made of polyolefin RT2535 with and without a halogen source in the form of a TBAI iodine salt were prepared using the following procedure.

Article 4C. Article 4C was prepared according to the procedure as described for Article 4BB. A permeation control material in the form of Hot Melt Adhesive 4B was melted on top of a first hot plate (temperature setting˜220° C.). A first SPC Material 4B piece with the size of 14×30 cm was placed on a second hot plate with a temperature of ˜120° C. Samples were prepared using the procedure described for the Article 4BB, however before pouring Hot Melt Adhesive 4B on the first SPC piece, a predetermined amount of Iodide salt 4A (TBAI) was mixed with Hot Melt Adhesive 4B using a glass stirring rod. The average content of TBAI in the polyolefin was about 22% by weight. Before the hot melt adhesive solidified, a second piece of SPC Material 4B was placed on top and it was gently pressed by hand and spatula until a bond was formed. Article 4C had an average thickness of ˜1.85 mm. The average thickness of the Hot Melt Adhesive Layer was about 0.5-0.6 mm, estimated by subtracting the thickness of the two SPC Material 4B from that of article 4C.

Thereby a three layer SPC laminate (Article 4C) was formed with two SPC layers (SCP material 4B) and a halogen reservoir made of permeation control material (Hot Melt Adhesive 4B) mixed with a halogen source (Iodide Salt) 4A between the two SPC layers.

Flue Gas Stream Durability Test

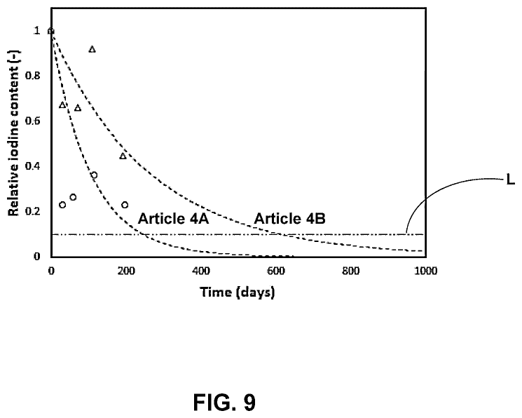

Articles 4A and 4B together with Articles 4AA and 4BB were mounted in the flue gas durability tests and iodine content was measured over time as described in Table 5. The iodine release rate constant k, for the Article 4A was 0.94%/day, and for Article 4B was 0.38%/day. FIG. 9 illustrates the relative iodine content of Article 4A and Article 4B. When the flue gas stream durability data was extrapolated using the exponential release rate (decay) model as shown also in FIG. 9 by respective dashed lines, Article 4A displayed iodine release of less than 300 hours before approaching 90% depletion (illustrated by the horizontal line L). Article 4B displayed iodine release of about 600 hours before approaching 90% depletion.

TABLE 5
Flue Gas Stream Durability Test

| | Article 4A | | | Article 4B | |
|---|---|---|---|---|---|
| | Total Iodine, | relative | | | relative |
| | content in | iodine | | Total Iodine, | iodine |
| Days | wt % | content | Days | content in wt % | content |
| 0 | 2.147 | 1 | 0 | 3.137 | 1 |
| 31 | 0.490 | 0.228 | 31 | 2.114 | 0.674 |
| 60 | 0.566 | 0.264 | 71 | 2.074 | 0.661 |
| 115 | 0.776 | 0.361 | 109 | 2.883 | 0.919 |
| 197 | 0.489 | 0.228 | 191 | 1.399 | 0.446 |

Strips of Article 4AA were collected after 75 and 197 days of exposure. Their total iodine content was 0.006 wt % and 0.07 wt % respectively. Strips of Article 4BB were collected after 71 and 191 days of exposure. Their total iodine content was 0.003 wt % and 0.03 wt % respectively. The low level of total iodine content for Articles 4AA and 4BB indicated that during the period of this test there was no significant source of iodine in the flue gas stream that could deposit in the samples. That is, Articles 4AA and 4BB did not gain any iodine.

Simulated Flue Gas Stream Durability Test

Article 4B and Article 4C were mounted in the simulated lab durability test and the iodine concentration was measured over time as described in Table 6. Both Article 4B (average of two samples) and Article 4C (average of two samples) did not lose any iodine over the duration of the test. The release rate constant (iodine content decay constant k) is about zero.

TABLE 6
Simulated Lab Durability Test

| | Article 4B | | Article 4C | |
|---|---|---|---|---|
| | Total Iodine | relative | | relative |
| Time | content in | iodine | Total Iodine | iodine |
| (days) | wt % | content | content in wt % | content |
| 0 | 3.14 | 1.00 | 2.545 | 1.00 |
| 30 | 3.15 | 1.00 | 2.582 | 1.00 |

### Comparative Example

SPC Comparative Sample 5A. A sorbent polymer composite (SPC) was created under laboratory conditions comprised of 40% activated carbon (NUCHAR SA-20, Ingevity, SC, USA), 50% PTFE, 3% potassium iodide (KI) as halogen source, and 7% sulfur and was prepared using the general dry blending methodology taught in U.S. Pat. No. 7,791,861 to form composite samples that were then uniaxially expanded according to the teachings of U.S. Pat. No. 3,953,566.

SPC Comparative Sample 5B. A sorbent polymer composite (SPC) was created under laboratory conditions comprised of 50% activated carbon (NUCHAR SA-20, Ingevity, SC, USA), 39% PTFE, 6% tetrabutylammonium iodide (TBAI) as halogen source, and 5% sulfur and was prepared using the general dry blending methodology taught in U.S. Pat. No. 7,791,861 to form composite samples that were then uniaxially expanded according to the teachings of U.S. Pat. No. 3,953,566.

Simulated Flue Gas Stream Durability Test

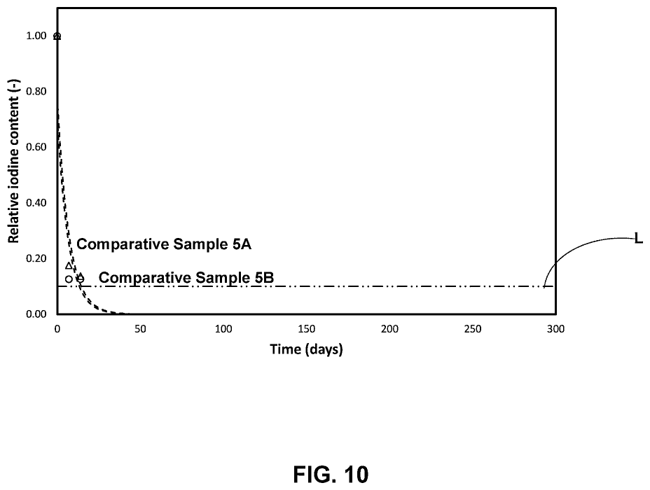

SPC comparative samples 5A and 5B were mounted in the simulated flue gas durability tests and the relative iodine content was tracked over time as described in Table 7. The halogen release rate constant (iodine content decay constant, k,) was determined to be 17.7%/day for SPC Comparative Sample 5A, and 16.3%/day for SPC Comparative Sample 5B. The relative iodine contents for comparative samples 5A and 5B were shown in FIG. 10. FIG. 10 shows the relative iodine content measured over a time period of 14 days. When the flue gas stream durability data was extrapolated using the exponential release rate (decay) model as shown also in FIG. 10 by respective dashed lines, SPC Comparative Samples 5A and 5B displayed iodine release for only about 15 days before approaching 90% depletion (illustrated by the horizontal line L).

TABLE 7
Simulated Flue Gas Stream Durability

| | Comparative | Comparative |
|---|---|---|
| | Sample 5A | Sample 5B |
| | relative iodine | Relative iodine |
| Time (days) | content | content |
| 0 | 1.00 | 1.00 |
| 7 | 0.13 | 0.18 |
| 14 | 0.13 | 0.14 |

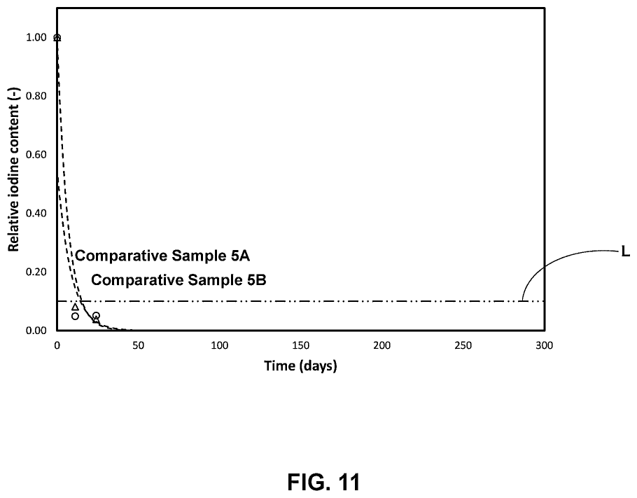

Flue Gas Stream Durability Test. SPC Comparative Samples 5A and 5B were mounted in the flue gas stream durability test. The relative iodine content was tracked over time as described in Table 8. The halogen release rate constant (iodine content decay constant, k) was determined to be 15%/day for SPC Comparative Sample 5A, and 9.0%/day for SPC Comparative Sample 5B. As shown in Table 8 and FIG. 11, Comparative Samples 5A and 5B reach 90% iodine depletion in less than 10 days (as illustrated by horizontal line L). The relative iodine content of FIG. 11 was measured over a period of 24 and 51 days, respectively.

TABLE 8
Flue Gas Stream Durability Test

| | Comparative | Comparative |
|---|---|---|
| | Sample 5A | Sample 5B |
| Time (days) | Relative iodine content | Relative iodine content |
| 0 | 1.00 | 1.00 |
| 11 | 0.05 | 0.08 |
| 24 | 0.05 | 0.04 |
| 51 | | 0.02 |

### ASPECTS

Various Aspects are described below. It is to be understood that any one or more of the features recited in the following Aspect(s) can be combined with any one or more other Aspect(s).
Aspect 1. An article comprising:
   a first sorbent polymer composite (SPC) layer;
   a second SPC layer; and
   a halogen reservoir,
   wherein the halogen reservoir is disposed between the first SPC layer and the second SPC layer.
Aspect 2. The article of Aspect 1, further comprising at least one permeation control material.
Aspect 3. The article according to any one or combination of the preceding and following Aspect(s), wherein the at least one permeation control material is in a form of at least one permeation control layer,
   wherein the at least one permeation control layer is disposed:
   between the first SPC layer and the halogen reservoir,
   between the second SPC layer and the halogen reservoir, or both.
Aspect 4. The article according to any one or combination of the preceding and following Aspect(s), wherein the at least one permeation control layer comprises:
   a first layer of the at least one permeation control material,
   wherein the first layer is disposed between the first SPC layer and the halogen reservoir; and
   a second layer of the at least one permeation control material,
   wherein the second layer is disposed between the second SPC layer and the halogen reservoir.
Aspect 5. The article according to any one or combination of the preceding and following Aspect(s), wherein the halogen reservoir comprises at least one halogen source.
Aspect 6. The article according to any one or combination of the preceding and following Aspect(s), wherein the at least one halogen source comprises at least one halide ion or an elemental halogen.
Aspect 7. The article according to any one or combination of the preceding and following Aspect(s), wherein the halogen reservoir comprises 0.1 wt % to 50 wt % of the at least one halogen source based on a total weight of the halogen reservoir.
Aspect 8. The article according to any one or combination of the preceding and following Aspect(s), wherein the halogen reservoir comprises an SPC.
Aspect 9. The article according to any one or combination of the preceding and following Aspect(s), wherein the halogen reservoir comprises a third SPC layer.
Aspect 10. The article according to any one or combination of the preceding and following Aspect(s), wherein at least one of the first SPC layer, the second SPC layer, or the third SPC layer comprises at least one halogen source.
Aspect 11. The article according to any one or combination of the preceding and following Aspect(s), wherein the halogen reservoir comprises at least one permeation control material.
Aspect 12. The article according to any one or combination of the preceding and following Aspect(s), wherein the halogen reservoir comprises:
   5 wt % to 95 wt % of the at least one permeation control material based on a total weight of the halogen reservoir; and
   5 wt % to 50 wt % of at least one halogen source based on a total weight of the halogen reservoir.
Aspect 13. The article according to any one or combination of the preceding and following Aspect(s), wherein the at least one permeation control material comprises:
   a first permeation control material; and
   a second permeation control material,
   wherein the second permeation control material is in a form of at least one layer of the second permeation control material,
   wherein the at least one layer of the second permeation control material is disposed:
   between the first SPC layer and the halogen reservoir,
   between the second SPC layer and the halogen reservoir, or
   between the first SPC layer and the halogen reservoir and also between the second SPC layer and the halogen reservoir.
Aspect 14. The article according to any one or combination of the preceding and following Aspect(s), wherein the at least one layer of the second permeation control material comprises:
   a first layer of the second permeation control material,
   wherein the first layer of the second permeation control material is disposed between the first SPC layer and the halogen reservoir; and
   a second layer of the second permeation control material,
   wherein the second layer of the second permeation control material is disposed between the second SPC layer and the halogen reservoir.
Aspect 15. The article according to any one or combination of the preceding and following Aspect(s), wherein the halogen reservoir further comprises carbon particles.
Aspect 16. The article according to any one or combination of the preceding and following Aspect(s), wherein the carbon particles are embedded within the at least one permeation control material.
Aspect 17. The article according to any one or combination of the preceding and following Aspect(s),
   wherein the article has a release rate of total halogens from the article that does not exceed 0.5% of the total halogens in the article per day, upon flowing a flue gas stream over at least one surface of the article over a time period of at least 90 days,
   wherein the flue gas stream has a temperature of at least 50° C. and a relative humidity of at least 95%, and wherein the flue gas stream comprises at least one SOₓ compound in a concentration of at least 20 ppm, and mercury vapor in a concentration of at least 1 μg/m³ of the flue gas stream.
Aspect 18. The article according to any one or combination of the preceding and following Aspect(s),
   wherein the article has a release rate of total halogens from the article that does not exceed 2% of the total halogens in the article per day, upon flowing a flue gas stream over at least one surface of the article over a time period of at least 90 days,
   wherein the flue gas stream has a temperature of at least 20° C. and a relative humidity of at least 95%, and wherein the flue gas stream comprises at least one SOₓ compound in a concentration of at least 1 ppm, and mercury vapor in a concentration of at least 1 μg/m³ of the flue gas stream.
Aspect 19. The article according to any one or combination of the preceding and following Aspect(s), wherein the article comprises a filter laminate, a layered filter material, an SPC laminate, or a layered SPC material.
Aspect 20. A method for forming an article, comprising:
   obtaining a first sorbent polymer composite (SPC) layer;
   obtaining a second SPC layer;
   obtaining a halogen reservoir;
   disposing the halogen reservoir between the first SPC layer and the second SPC layer so as to result in a layered structure; and
   adhering the layered structure together to form the article.
Aspect 21. The method according to any one or combination of the preceding and following Aspect(s), wherein the disposing the halogen reservoir between the first SPC layer and the second SPC layer comprises:
   disposing at least one permeation control layer between the first SPC layer and the halogen reservoir,
   disposing the at least one permeation control layer between the second SPC layer and the halogen reservoir, or
   both,
   such that the article formed comprises at least one permeation control layer.
Aspect 22. The method according to any one or combination of the preceding and following Aspect(s), wherein the disposing the halogen reservoir between the first SPC layer and the second SPC layer comprises:
   disposing a first layer of at least one permeation control material between the first SPC layer and the halogen reservoir; and
   disposing a second layer of the at least one permeation control material between the second SPC layer and the halogen reservoir.
Aspect 23. The method according to any one or combination of the preceding and following Aspect(s), further comprising:
   combining at least one halogen source with at least one permeation control material, so as to form the halogen reservoir,
   wherein the halogen reservoir comprises:
   the at least one halogen source, and
   the at least one permeation control material.
Aspect 24. The method according to any one or combination of the preceding and following Aspect(s), wherein the combining the at least one halogen source with the at least one permeation control material comprises:
   heating the at least one permeation control material to a temperature sufficient to melt the at least one permeation control material; and
   mixing the at least one melted permeation control material with at least one halogen source.
Aspect 25. The method according to any one or combination of the preceding and following Aspect(s), wherein the temperature sufficient to melt the at least one permeation control material ranges from 130° C. to 180° C.
Aspect 26. The method according to any one or combination of the preceding and following Aspect(s), wherein the combining of the at least one halogen source with the at least one permeation control material comprises:
   dissolving the at least one permeation control material in a solvent so as to form a mixture;
   adding at least one halogen source to the mixture of the solvent and the at least one permeation control material; and
   evaporating the solvent.
Aspect 27. The method according to any one or combination of the preceding and following Aspect(s), further comprising adding particles to the mixture of the at least one halogen source, solvent, and the at least one permeation control material.
Aspect 28. The method according to any one or combination of the preceding and following Aspect(s), wherein the particles are carbon particles.
Aspect 29. The method according to any one or combination of the preceding and following Aspect(s), wherein the combining of the at least one halogen source with the at least one permeation control material comprises:
   forming a chemical complex with the at least one halogen source and the at least one permeation control material.
Aspect 30. The method according to any one or combination of the preceding and following Aspect(s), wherein the at least one halogen source is in a solution.
Aspect 31. The method according to any one or combination of the preceding and following Aspect(s), wherein the at least one halogen source is in a gas phase.
Aspect 32. The method according to any one or combination of the preceding and following Aspect(s), wherein the at least one halogen source is a salt.
Aspect 33. The method according to any one or combination of the preceding and following Aspect(s), further comprising:
   flowing a flue gas stream over at least one surface of the article over a time period of at least 90 days,
   wherein the flue gas stream has a temperature of at least 50° C. and a relative humidity of at least 95%,
   wherein the flue gas stream comprises:
   at least one SOₓ compound in a concentration of at least 20 ppm, and
   mercury vapor in a concentration of at least 1 μg/m³ based on a total volume of the flue gas stream,
   wherein a release rate of total halogens in the article does not exceed 0.5% of total halogens in the article per day during the flowing the flue gas stream.
Aspect 34. The method according to any one or combination of the preceding Aspect(s), further comprising:
   flowing a flue gas stream over at least one surface of the article over a time period of at least 90 days,
   wherein the flue gas stream has a temperature of at least 20° C. and a relative humidity of at least 95%,
   wherein the flue gas stream comprises:
   at least one SOₓ compound in a concentration of at least 1 ppm, and
   mercury vapor in a concentration of at least 1 μg/m³ based on a total volume of the flue gas stream,
   wherein a release rate of total halogens in the article does not exceed 2% of total halogens in the article per day during the flowing the flue gas stream.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. An article comprising:
a first sorbent polymer composite (SPC) layer;
a second SPC layer; and
a halogen reservoir,
wherein the halogen reservoir is disposed between the first SPC layer and
the second SPC layer.

2. The article of claim 1, further comprising at least one permeation control material.

3. The article of claim 2, wherein the at least one permeation control material is in a form of at least one permeation control layer,
wherein the at least one permeation control layer is disposed:
between the first SPC layer and the halogen reservoir,
between the second SPC layer and the halogen reservoir, or
both.

4. The article of claim 3, wherein the at least one permeation control layer comprises:
a first layer of the at least one permeation control material,
wherein the first layer is disposed between the first SPC layer and the halogen reservoir; and
a second layer of the at least one permeation control material,
wherein the second layer is disposed between the second SPC layer and the halogen reservoir.

5. The article according to claim 1, wherein the halogen reservoir comprises at least one halogen source.

6. (canceled)

7. (canceled)

8. The article of claim 1, wherein the halogen reservoir comprises an SPC.

9. The article of claim 1, wherein the halogen reservoir comprises a third SPC layer.

10. The article of claim 9, wherein at least one of the first SPC layer, the second SPC layer, or the third SPC layer comprises at least one halogen source.

11. The article of claim 1, wherein the halogen reservoir comprises at least one permeation control material.

12. (canceled)

13. The article of claim 2, wherein the at least one permeation control material comprises:
a first permeation control material; and
a second permeation control material,
wherein the second permeation control material is in a form of at least one layer of the second permeation control material,
wherein the at least one layer of the second permeation control material is disposed:
between the first SPC layer and the halogen reservoir,
between the second SPC layer and the halogen reservoir, or
between the first SPC layer and the halogen reservoir and also
between the second SPC layer and the halogen reservoir.

14. The article of claim 13, wherein the at least one layer of the second permeation control material comprises:
a first layer of the second permeation control material,
wherein the first layer of the second permeation control material is disposed between the first SPC layer and the halogen reservoir; and
a second layer of the second permeation control material,
wherein the second layer of the second permeation control material is disposed between the second SPC layer and the halogen reservoir.

15. The article of claim 11, wherein the halogen reservoir further comprises carbon particles.

16. The article of claim 15, wherein the carbon particles are embedded within the at least one permeation control material.

17. The article of claim 1,
wherein the article has a release rate of total halogens from the article that does not exceed 0.5% of the total halogens in the article per day, upon flowing a flue gas stream over at least one surface of the article over a time period of at least 90 days,
wherein the flue gas stream has a temperature of at least 50° C. and a relative humidity of at least 95%, and wherein the flue gas stream comprises at least one SOₓ compound in a concentration of at least 20 ppm, and mercury vapor in a concentration of at least 1 μg/m³ of the flue gas stream.

18. (canceled)

19. The article of claim 1, wherein the article comprises a filter laminate, a layered filter material, an SPC laminate, or a layered SPC material.

20. A method for forming an article, comprising:
obtaining a first sorbent polymer composite (SPC) layer;
obtaining a second SPC layer;
obtaining a halogen reservoir;
disposing the halogen reservoir between the first SPC layer and the second SPC layer so as to result in a layered structure; and
adhering the layered structure together to form the article.

21. The method of claim 20, wherein the disposing the halogen reservoir between the first SPC layer and the second SPC layer comprises:
disposing at least one permeation control layer between the first SPC layer and the halogen reservoir,
disposing the at least one permeation control layer between the second SPC layer and the halogen reservoir, or
both,
such that the article formed comprises at least one permeation control layer.

22. The method of claim 20, wherein the disposing the halogen reservoir between the first SPC layer and the second SPC layer comprises:
disposing a first layer of at least one permeation control material between the first SPC layer and the halogen reservoir; and
disposing a second layer of the at least one permeation control material between the second SPC layer and the halogen reservoir.

23. The method of claim 20, further comprising:
combining at least one halogen source with at least one permeation control material, so as to form the halogen reservoir,
wherein the halogen reservoir comprises:
the at least one halogen source, and
the at least one permeation control material.

24. The method of claim 23, wherein the combining the at least one halogen source with the at least one permeation control material comprises:
heating the at least one permeation control material to a temperature sufficient to melt the at least one permeation control material; and
mixing the at least one melted permeation control material with at least one halogen source.

25. The method of claim 24, wherein the temperature sufficient to melt the at least one permeation control material ranges from 130° C. to 180° C.

26. The method according to claim 23, wherein the combining of the at least one halogen source with the at least one permeation control material comprises:
dissolving the at least one permeation control material in a solvent so as to form a mixture;
adding at least one halogen source to the mixture of the solvent and the at least one permeation control material; and
evaporating the solvent.

27. The method of claim 26, further comprising adding particles to the mixture of the at least one halogen source, solvent, and the at least one permeation control material.

28. (canceled)

29. The method of claim 23, wherein the combining of the at least one halogen source with the at least one permeation control material comprises:
forming a chemical complex with the at least one halogen source and the at least one permeation control material.

30. (canceled)

31. (canceled)

32. (canceled)

33. The method according to claim 20, further comprising:
flowing a flue gas stream over at least one surface of the article over a time period of at least 90 days,
wherein the flue gas stream has a temperature of at least 50° C. and a relative humidity of at least 95%,
wherein the flue gas stream comprises:
at least one SOₓ compound in a concentration of at least 20 ppm, and
mercury vapor in a concentration of at least 1 μg/m³ based on a total volume of the flue gas stream,
wherein a release rate of total halogens in the article does not exceed 0.5% of total halogens in the article per day during the flowing the flue gas stream.

34. (canceled)
